(19) United States
(12) Patent Application Publication
(10) Pub. No.: US 2025/0317704 A1
(43) Pub. Date: Oct. 9, 2025

(54) CONTEXT-AWARE NAVIGATION

(71) Applicant: QUALCOMM Incorporated, San Diego, CA (US)

(72) Inventors: Harleen GILL, Los Altos, CA (US); Guruprasad Prabhakar CHINNABHANDAR, San Diego, CA (US); Alexandros MANOLAKOS, Athens (GR); Bala RAMASAMY, San Marcos, CA (US); Grant MARSHALL, Campbell, CA (US); Gurdarshan SINGH, Dublin, CA (US); Mark Aaron LINDNER, Broomfield, CO (US); Kin WONG, Campbell, CA (US); Chandrakant MEHTA, Cupertino, CA (US)

(21) Appl. No.: 18/872,260

(22) PCT Filed: Jun. 28, 2023
(86) PCT No.: PCT/US2023/026499

§ 371 Date: Dec. 5, 2024

(30) Foreign Application Priority Data
Jul. 19, 2022 (GR) 20220100573

(51) Int. Cl. H04W 4/021; H04L 67/00; H04L 67/52

(52) U.S. Cl. CPC H04W 4/021; H04L 67/34; H04L 67/52

(57) ABSTRACT

Aspects presented herein relate to methods and devices for wireless communication including an apparatus, e.g., a device or a server. The apparatus may obtain a set of device parameters for one or more route segments from a server, wherein the set of device parameters for the one or more route segments includes an indication of an operation of the device along each of the one or more route segments. Additionally, the apparatus may set one or more device parameters of the set of device parameters for the one or more route segments based on a proximity of the device to a corresponding route segment of the one or more route segments.

### CROSS-REFERENCE TO RELATED APPLICATION

This application claims the benefit of Greece Patent Application Serial No. 20220100573, entitled “CONTEXT-AWARE NAVIGATION” and filed on Jul. 19, 2022, which is expressly incorporated by reference herein in its entirety.

### TECHNICAL FIELD

The present disclosure relates generally to communication systems, and more particularly, to positioning measurements in wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be an apparatus for wireless communication at a device or a user equipment (UE). The apparatus may obtain an indication of one or more route segments prior to obtaining a set of device parameters, where the indication is obtained based on at least one of: information from at least one external source, information from at least one internal source, information from a database, a machine learning (ML) model, a neural network (NN) model, or a combination thereof. The apparatus may also obtain a set of device parameters for one or more route segments from a server, where the set of device parameters for the one or more route segments includes an indication of an operation of the device along each of the one or more route segments. Further, the apparatus may set one or more device parameters of the set of device parameters for the one or more route segments based on a proximity of the device to a corresponding route segment of the one or more route segments. The apparatus may also receive an indication of a reporting capability of the device, where the reporting capability indicates whether the device includes a capability to report on behalf of one or more additional devices. The apparatus may also configure one or more sensors of the device based on the set of device parameters for the one or more route segments. Moreover, the apparatus may monitor for at least one transmission-reception point (TRP) corresponding to a relative distance to at least one other geofence associated with the absolute geofence or the relative geofence; and select a sleep duration based on an expected time to travel the relative distance to the at least one other geofence. The apparatus may also update at least one of sensing data or the set of device parameters for the one or more route segments based on one or more route conditions along the one or more route segments; and transmit a second indication of at least one of the updated sensing data or the updated set of device parameters, where the second indication is transmitted to the server. The apparatus may also receive a warning indication from the server if a location of the device is greater than a threshold distance from at least one of a list of target locations for the one or more route segments, where the location of the device is based on the updated sensing data or the updated set of device parameters.

In an aspect of the disclosure, a method, a computer-readable medium, and an apparatus are provided. The apparatus may be an apparatus for wireless communication at a server or a network entity. The apparatus may select one or more route segments based on a set of route conditions or a set of environmental conditions associated with the one or more route segments; and transmit a second indication of the selected one or more route segments. The apparatus may also obtain an indication of one or more route segments associated with one or more devices. Further, the apparatus may select a set of device parameters for the one or more route segments, where the set of device parameters for the one or more route segments includes an indication of an operation of the one or more devices along each of the one or more route segments, where one or more device parameters of the set of device parameters are based on a proximity of the one or more devices to a corresponding route segment of the one or more route segments. The apparatus may also transmit the set of device parameters for the one or more route segments to the one or more devices. The apparatus may also transmit an indication of a reporting capability of each of the one or more devices, where the reporting capability indicates whether each of the one or more devices includes a capability to report on behalf of one or more additional devices. Moreover, the apparatus may receive a second indication of at least one of updated sensing data or an updated set of device parameters; and detect whether a location of the one or more devices corresponds to a list of target locations for the one or more route segments based on at least one of the updated sensing data or the updated set of device parameters. The apparatus may also transmit a warning indication to at least one device of the one or more devices if the location of the at least one device is greater than a threshold distance from at least one of the list of target locations for the one or more route segments.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a wireless communication system.

FIG. 6 is a diagram illustrating an example positioning procedure.

FIG. 7 is a diagram illustrating an example route for a device in a wireless communication system.

FIG. 8 is a diagram illustrating an example route for a device in a wireless communication system.

FIG. 9 is a diagram illustrating an example route for a device in a wireless communication system.

FIG. 10 is a diagram illustrating an example route for a device in a wireless communication system.

FIG. 11 is a communication flow diagram illustrating example communications between a device and a server.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

FIG. 18 is a diagram illustrating an example of a hardware implementation for an example network entity.

### DETAILED DESCRIPTION

Aspects of communication or device configuration may utilize a number of different mapping or navigation processes for devices (e.g., an internet of things (IoT) device). For instance, a mapping or navigation process may navigate a device along a certain route or route segment, as well as determine or update a location of the device along the route or route segment. Accordingly, mapping or navigation processes are similar to position location processes in that device locations may be determined along a route or route segment. However, certain types of mapping or navigation processes may not utilize some types of positioning technologies. For example, an operating system of a mapping or navigation process may dictate which positioning technologies may be used for a given location request (e.g., a location request on the device or smartphone side). Also, a server or network (NW) may dictate a periodicity of a particular positioning technology, regardless of the scenario within the mapping or navigation process. That is, a server or network (e.g., a lower level server/network) may select a particular positioning technology for a number of reasons, such as to reduce power consumption. Additionally, there may be certain geographical areas where positioning technologies yield poor results and cause battery drainage (e.g., battery drainage at the device). Accordingly, this may result in a false sense of reliability for determining a location of a device with certain types of positioning technologies. Also, classification of a movement pattern of a device may change based on the context of the route or area within a certain proximity to the device. However, these factors may not take into account how the environment or environment factors along the route or route segment may affect devices or packages that are being transported along the route or route segment. In some types of environments, certain positioning technologies may not perform well compared to other positioning technologies. For instance, in some approaches (e.g., a commoditized approach), a device (e.g., a tracking device) without knowledge of a route or route segment may continue trying to perform a particular position fix in certain situations (e.g., a dense urban environment), where a certain positioning technology (e.g., global navigation satellite system (GNSS)) may not perform well. Also, in these situations (e.g., a dense urban environment) certain positioning technologies may request that the device to stay awake for longer periods of time than normal, which may drain battery power at the device. In some scenarios, after computing a position fix, a device may take a significant amount of time trying to reconnect to a network in a location where the network is spotty or unavailable (e.g., a rural environment). Additionally, in some scenarios, a device may need to be prompted (e.g., prompted by a server) to change a quality of service (QOS) or positioning technology, which may also result in an increased battery consumption at the device. Aspects of the present disclosure may indicate to devices that certain positioning technologies are to be utilized for determining the device positioning. For instance, devices herein may receive an indication of which positioning technologies to utilize in certain scenarios (e.g., certain environments or sections of a route). In some instances, prior to a route or a particular route segment, devices herein may be preconfigured with the positioning technologies to utilize in certain environments (e.g., a dense urban environment or a rural environment) or certain route sections. By doing so, devices herein may utilize a reduced amount of battery consumption, as they may not need to be prompted to change a QoS or positioning technology in certain scenarios. That is, aspects presented herein may lower the power consumption of devices by indicating the suitable or desired methodologies for determining the positioning of each device. For instance, devices herein may receive (e.g., from a server) an indication of a suitable or desired methodology for determining the positioning of the device when the device is in a particular environment or segment of a route.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

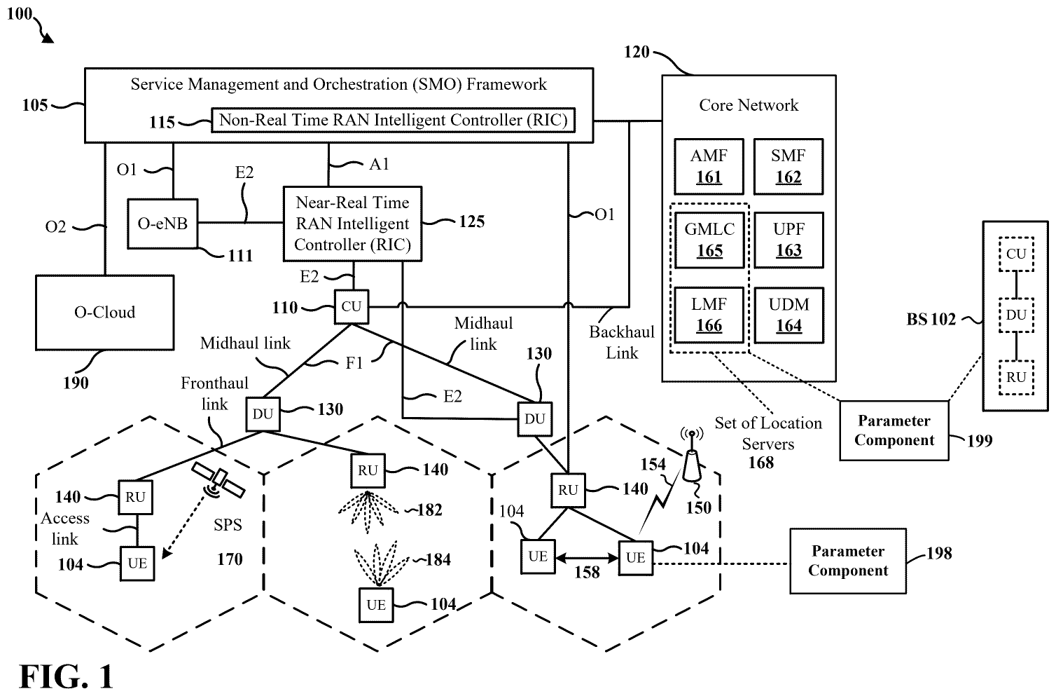

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network. In some scenarios, the term UE may also apply to one or more companion devices such as in a device constellation arrangement. One or more of these devices may collectively access the network and/or individually access the network. A network node can be implemented as a base station (i.e., an aggregated base station), as a disaggregated base station, an integrated access and backhaul (IAB) node, a relay node, a sidelink node, etc. A network entity can be implemented as a base station (i.e., an aggregated base station), or alternatively, as a central unit (CU), a distributed unit (DU), a radio unit (RU), a Near-Real Time (Near-RT) RAN Intelligent Controller (RIC), or a Non-Real Time (Non-RT) RIC in a disaggregated base station architecture.

Referring again to FIG. 1, in certain aspects, the UE 104 may include a parameter component 198 that may be configured to obtain an indication of one or more route segments prior to obtaining a set of device parameters, where the indication is obtained based on at least one of: information from at least one external source, information from at least one internal source, information from a database, a machine learning (ML) model, a neural network (NN) model, or a combination thereof. Parameter component 198 may also be configured to obtain a set of device parameters for one or more route segments from a server, where the set of device parameters for the one or more route segments includes an indication of an operation of the device along each of the one or more route segments. Parameter component 198 may also be configured to set one or more device parameters of the set of device parameters for the one or more route segments based on a proximity of the device to a corresponding route segment of the one or more route segments. Parameter component 198 may also be configured to receive an indication of a reporting capability of the device, where the reporting capability indicates whether the device includes a capability to report on behalf of one or more additional devices. Parameter component 198 may also be configured to configure one or more sensors of the device based on the set of device parameters for the one or more route segments. Parameter component 198 may also be configured to monitor for at least one transmission-reception point (TRP) corresponding to a relative distance to at least one other geofence associated with the absolute geofence or the relative geofence; and select a sleep duration based on an expected time to travel the relative distance to the at least one other geofence. Parameter component 198 may also be configured to update at least one of sensing data or the set of device parameters for the one or more route segments based on one or more route conditions along the one or more route segments; and transmit a second indication of at least one of the updated sensing data or the updated set of device parameters, where the second indication is transmitted to the server. Parameter component 198 may also be configured to receive a warning indication from the server if a location of the device is greater than a threshold distance from at least one of a list of target locations for the one or more route segments, where the location of the device is based on the updated sensing data or the updated set of device parameters.

In certain aspects, the base station 102 and/or LMF 166 may include a parameter component 199 that may be configured to select one or more route segments based on a set of route conditions or a set of environmental conditions associated with the one or more route segments; and transmit a second indication of the selected one or more route segments. Parameter component 199 may also be configured to obtain an indication of one or more route segments associated with one or more devices. Parameter component 199 may also be configured to select a set of device parameters for the one or more route segments, where the set of device parameters for the one or more route segments includes an indication of an operation of the one or more devices along each of the one or more route segments, where one or more device parameters of the set of device parameters are based on a proximity of the one or more devices to a corresponding route segment of the one or more route segments. Parameter component 199 may also be configured to transmit the set of device parameters for the one or more route segments to the one or more devices. Parameter component 199 may also be configured to transmit an indication of a reporting capability of each of the one or more devices, where the reporting capability indicates whether each of the one or more devices includes a capability to report on behalf of one or more additional devices. Parameter component 199 may also be configured to receive a second indication of at least one of updated sensing data or an updated set of device parameters; and detect whether a location of the one or more devices corresponds to a list of target locations for the one or more route segments based on at least one of the updated sensing data or the updated set of device parameters. Parameter component 199 may also be configured to transmit a warning indication to at least one device of the one or more devices if the location of the at least one device is greater than a threshold distance from at least one of the list of target locations for the one or more route segments. Although the following description may be focused on 5G NR, the concepts described herein may be applicable to other similar areas, such as LTE, LTE-A, CDMA, GSM, and other wireless technologies.

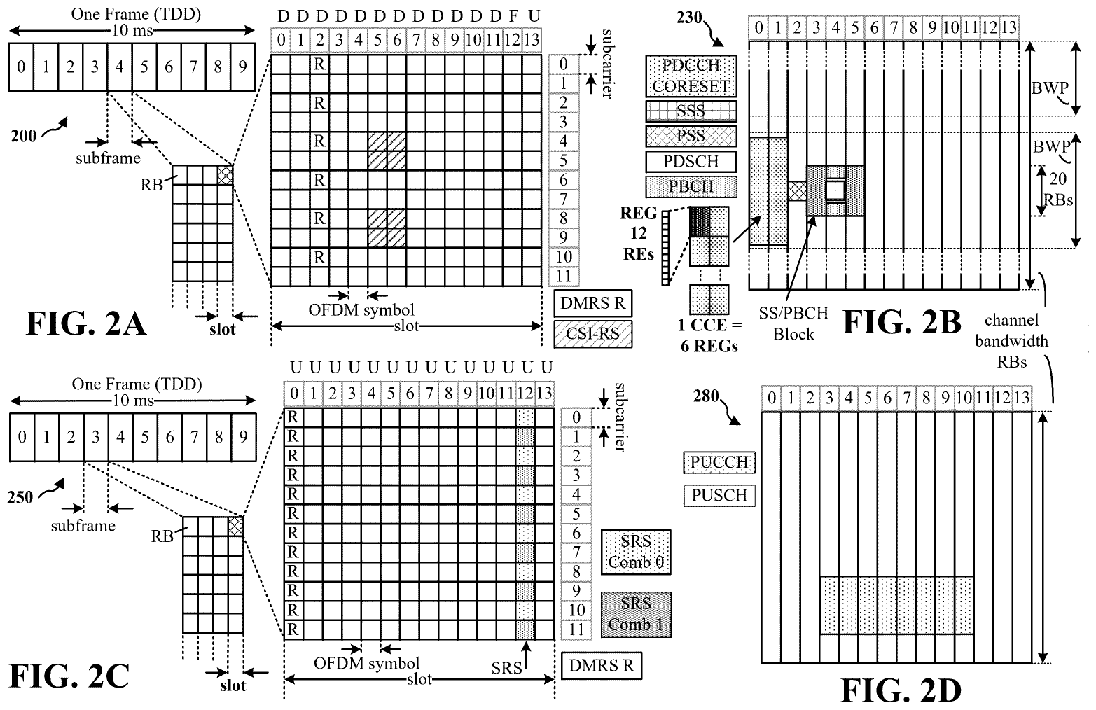

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

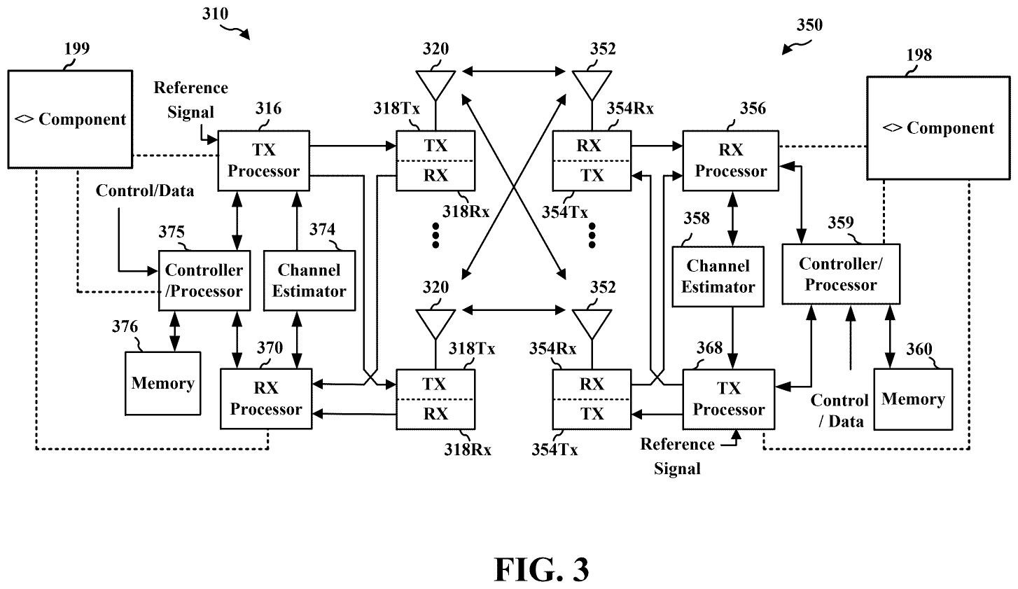

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the parameter component 198 of FIG. 1. At least one of the TX processor 316, the RX processor 370, and the controller/processor 375 may be configured to perform aspects in connection with the parameter component 199 of FIG. 1.

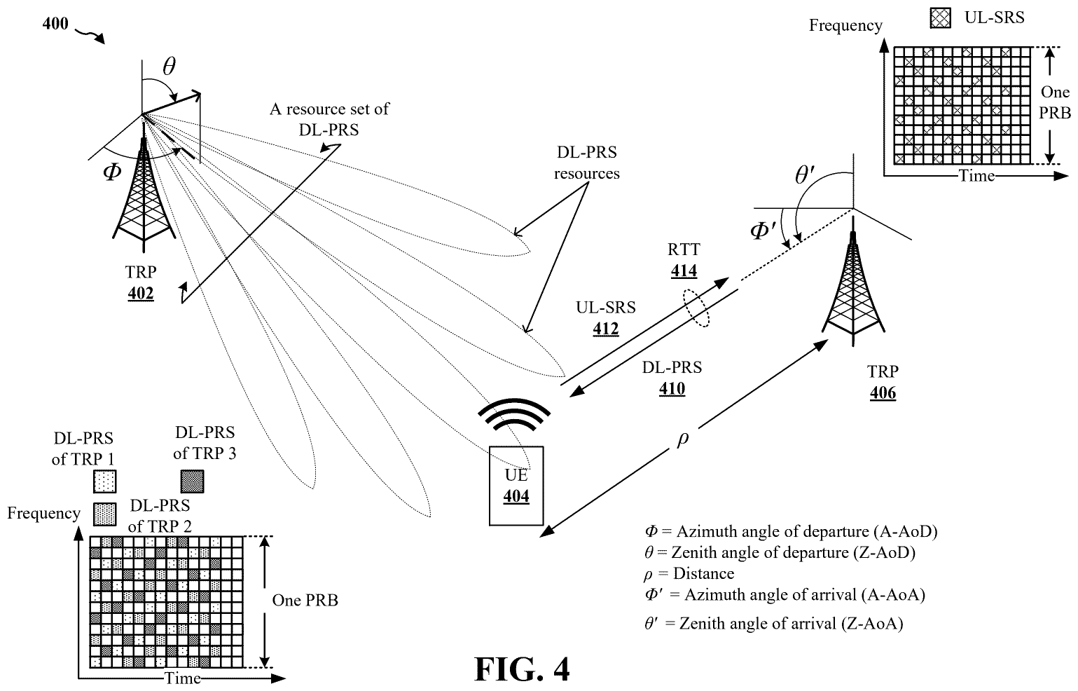

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406. DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404. UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine to and/or enhance certainty, to supplement/complement measurements, and/or to substitute/provide for missing information.

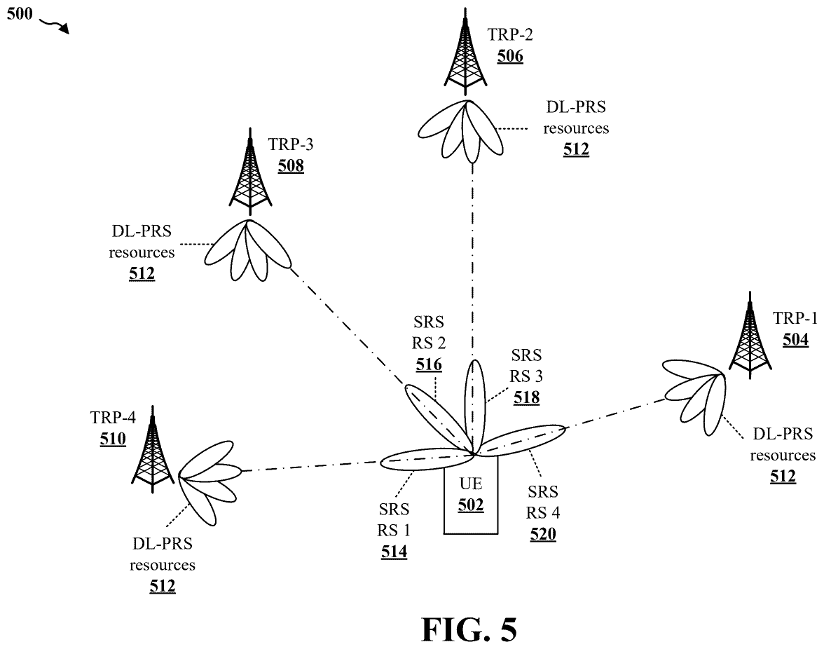

FIG. 5 is a diagram 500 illustrating an example of estimating a position of a UE based on multi-RTT measurements from multiple TRPs in accordance with various aspects of the present disclosure. A UE 502 may be configured by a serving base station to decode DL-PRS resources 512 that correspond to and are transmitted from a first TRP 504 (TRP-1), a second TRP 506 (TRP-2), a third TRP 508 (TRP-3), and a fourth TRP 510 (TRP-4). The UE 502 may also be configured to transmit UL-SRSs on a set of UL-SRS resources, which may include a first SRS resource 514, a second SRS resource 516, a third SRS resource 518, and a fourth SRS resource 520, such that the serving cell(s), e.g., the first TRP 504, the second TRP 506, the third TRP 508, and the fourth TRP 510, and as well as other neighbor cell(s), may be able to measure the set of the UL-SRS resources transmitted from the UE 502. For multi-RTT measurements based on DL-PRS and UL-SRS, as there may be an association between a measurement of a UE for the DL-PRS and a measurement of a TRP for the UL-SRS, the smaller the gap is between the DL-PRS measurement of the UE and the UL-SRS transmission of the UE, the better the accuracy may be for estimating the position of the UE and/or the distance of the UE with respect to each TRP.

In some aspects of wireless communication, the terms “positioning reference signal” and “PRS” may generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. In some aspects, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

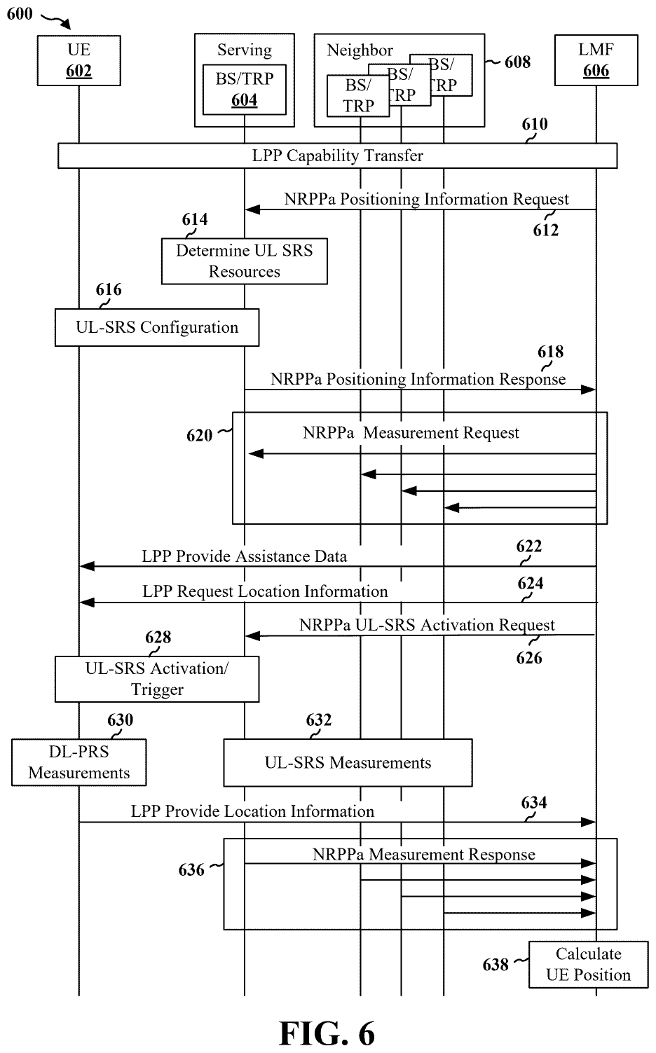

FIG. 6 is a communication flow 600 illustrating an example multi-RTT positioning procedure in accordance with various aspects of the present disclosure. The numberings associated with the communication flow 600 do not specify a particular temporal order and are merely used as references for the communication flow 600. In addition, a DL-only and/or an UL-only positioning may use a subset or subsets of this multi-RTT positioning procedure.

At 610, an LMF 606 may request one or more positioning capabilities from a UE 602 (e.g., from a target device). In some examples, the request for the one or more positioning capabilities from the UE 602 may be associated with an LTE Positioning Protocol (LPP). For example, the LMF 606 may request the positioning capabilities of the UE 602 using an LPP capability transfer procedure. At 612, the LMF 606 may request UL SRS configuration information for the UE 602. The LMF 606 may also provide assistance data specified by a serving base station 604 (e.g., pathloss reference, spatial relation, and/or SSB configuration(s), etc.). For example, the LMF 606 may send an NR Positioning Protocol A (NRPPa) positioning information request message to the serving base station 604 to request UL information for the UE 602.

At 614, the serving base station 604 may determine resources available for UL SRS, and at 616, the serving base station 604 may configure the UE 602 with one or more UL SRS resource sets based on the available resources. At 618, the serving base station 604 may provide UL SRS configuration information to the LMF 606, such as via an NRPPa positioning information response message. At 620, the LMF 606 may select one or more candidate neighbor BSs/TRPs 608, and the LMF 606 may provide an UL SRS configuration to the one or more candidate neighbor BSs/TRPs 608 and/or the serving base station 604, such as via an NRPPa measurement request message. The message may include information for enabling the one or more candidate neighbor BSs/TRPs 608 and/or the serving base station to perform the UL measurements.

At 622, the LMF 606 may send an LPP provide assistance data message to the UE 602. The message may include specified assistance data for the UE 602 to perform the DL measurements. At 624, the LMF 606 may send an LPP request location information message to the UE 602 to request multi-RTT measurements. At 626, for semi-persistent or aperiodic UL SRS, the LMF 606 may request the serving base station 604 to activate/trigger the UL SRS in the UE 602. For example, the LMF 606 may request activation of UE SRS transmission by sending an NRPPa positioning activation request message to the serving base station 604.

At 628, the serving base station 604 may activate the UE SRS transmission and send an NRPPa positioning activation response message. In response, the UE 602 may begin the UL-SRS transmission according to the time domain behavior of UL SRS resource configuration. At 630, the UE 602 may perform the DL measurements from the one or more candidate neighbor BSs/TRPs 608 and/or the serving base station 604 provided in the assistance data. At 632, each of the configured one or more candidate neighbor BSs/TRPs 608 and/or the serving base station 604 may perform the UL measurements. At 634, the UE 602 may report the DL measurements to the LMF 606, such as via an LPP provide location information message. At 636, each of the one or more candidate neighbor BSs/TRPs 608 and/or the serving base station 604 may report the UL measurements to the LMF 606, such as via an NRPPa measurement response message. At 638, the LMF 606 may determine the RTTs from the UE 602 and BS/TRP Rx-Tx time difference measurements for each of the one or more candidate neighbor BSs/TRPs 608 and/or the serving base station 604 for which corresponding UL and DL measurements were provided at 634 and 636, and the LMF 606 may calculate the position of the UE 602.

Aspects of communication or device configuration may utilize a number of different mapping or navigation processes for devices (e.g., an internet of things (IoT) device). For instance, a mapping or navigation process may navigate a device along a certain route or route segment, as well as determine or update a location of the device along the route or route segment. Accordingly, mapping or navigation processes are similar to position location processes in that device locations may be determined along a route or route segment. However, certain types of mapping or navigation processes may not utilize some types of positioning technologies. For example, an operating system of a mapping or navigation process may dictate which positioning technologies may be used for a given location request (e.g., a location request on the device or smartphone side). Also, a server or network (NW) may dictate a periodicity of a particular positioning technology, regardless of the scenario within the mapping or navigation process. That is, a server or network (e.g., a lower level server/network) may select a particular positioning technology for a number of reasons, such as to reduce power consumption. Indeed, a server/network may opportunistically select particular technologies for locating the device in order to reduce the power consumption at the device in a reactive manner.

Additionally, there may be certain geographical areas where positioning technologies yield poor results and cause battery drainage (e.g., battery drainage at the device). For example, certain areas or geofences (i.e., a virtual perimeter around a real-world geographic area) may cause a reduced performance for certain positioning technologies, as well as result in devices losing an excessive amount of battery power within the area. Accordingly, this may result in a false sense of reliability for determining a location of a device with certain types of positioning technologies. Also, classification of a movement pattern of a device may change based on the context of the route or area within a certain proximity to the device. Moreover, in some instances, destination routing for a device may be performed based on a number of factors, such as traffic conditions, localization reliability, etc. However, these factors may not take into account how the environment or environment factors along the route or route segment may affect devices or packages that are being transported along the route or route segment.

In some types of environments, certain positioning technologies may not perform well compared to other positioning technologies. For instance, in some approaches (e.g., a commoditized approach), a device (e.g., a tracking device) without knowledge of a route or route segment may continue trying to perform a particular position fix in certain situations (e.g., a dense urban environment), where a certain positioning technology (e.g., global navigation satellite system (GNSS)) may not perform well. Also, in these situations (e.g., a dense urban environment) certain positioning technologies may request that the device to stay awake for longer periods of time than normal, which may drain battery power at the device. In some scenarios, after computing a position fix, a device may take a significant amount of time trying to reconnect to a network in a location where the network is spotty or unavailable (e.g., a rural environment). Additionally, in some scenarios, a device may need to be prompted (e.g., prompted by a server) to change a quality of service (QOS) or positioning technology, which may also result in an increased battery consumption at the device. Based on the above, it may be beneficial for a device to understand the positioning technologies for determining its positioning. For example, it may be beneficial for a device to know the positioning technologies to use for certain environments or route sections.

Aspects of the present disclosure may indicate to devices that certain positioning technologies are to be utilized for determining the device positioning. For instance, devices herein may receive an indication of which positioning technologies to utilize in certain scenarios (e.g., certain environments or sections of a route). In some instances, prior to a route or a particular route segment, devices herein may be preconfigured with the positioning technologies to utilize in certain environments (e.g., a dense urban environment or a rural environment) or certain route sections. By doing so, devices herein may utilize a reduced amount of battery consumption, as they may not need to be prompted to change a QoS or positioning technology in certain scenarios. That is, aspects presented herein may lower the power consumption of devices by indicating the suitable or desired methodologies for determining the positioning of each device. For instance, devices herein may receive (e.g., from a server) an indication of a suitable or desired methodology for determining the positioning of the device when the device is in a particular environment or segment of a route.

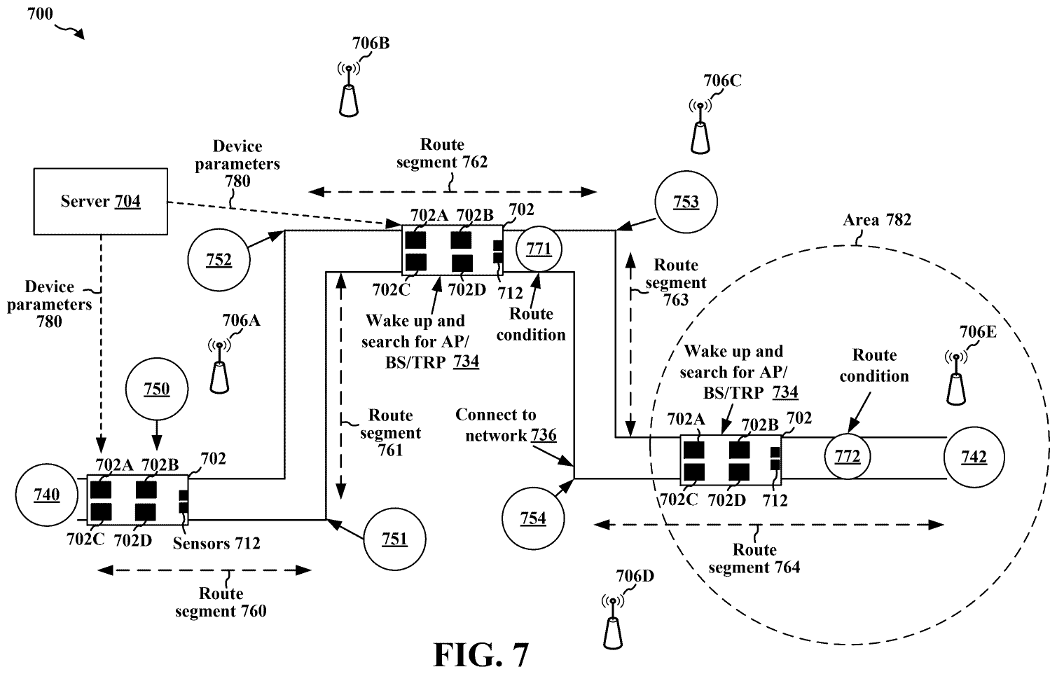

In some aspects, devices herein may receive an indication of a certain route or route segments (i.e., one or more segments or sections of a route or a path). The route segments may be combine together to form an entire route, or each of the route segments may be an individual route, such that all of the route segments correspond to multiple routes. For instance, a server (e.g., a cloud server) or a network may transmit an indication of a route or route segments to a device prior to the device embarking on the route or route segments. The indication of the route/route segments may indicate an expected route or expected points along a route/route segments for the device. Further, the route or route segments may indicate a sequence in which the expected points will occur along the route or route segments, as well as a sequence of the overall expected route or route segments. For example, the route or route segments may indicate the following sequence: (i) left turn or left motion pattern at a first point (point 1), (ii) right turn or right motion pattern at a second point (point 2), (iii) right turn or right motion pattern at a third point (point 3), (iv) left turn or left motion pattern at a fourth point (point 4), and (v) a pothole or a pothole motion pattern at a fifth point (point 5). For instance, this motion sequence may correspond to the motion sequence indicated in FIG. 7, as described below.

In some aspects, a server or network may obtain a route or a number points (e.g., an origin point and a destination point) that are associated with at least one device. The server or network may also receive a number of route segments (i.e., one or more segments of a route) for a device. For example, a server may obtain one or more routes or route segments from an origin point to a destination point. Additionally, the server may determine a number of device parameters for one or more route segments (e.g., road segments) associated with the route. That is, after obtaining the route or route segments, the server or network may select a set of device parameters (e.g., one or more device parameters) for the one or more route segments. In some instances, the set of device parameters for the route segments may include an indication of an operation of the device along each of the route segments. Further, at least one of the device parameters may be based on a proximity (e.g., a threshold distance) of the device to a corresponding route segment. The route or route segments may be indicated based on a certain area or perimeter near the route. For instance, the route segments (e.g., road segments) may be indicated based on a geofence (i.e., a virtual perimeter around a real-world geographic area), such as an absolute geofence or a relative geofence. The route segments may also be indicated based on a number of timers, time periods, and/or distances. At certain points along the route (or route segment), a device (e.g., a tracking device) may wake up and perform a search for a certain positioning technology or radio access technology (RAT), such as WiFi, WiFi received signal strength indicator (RSSI), WiFi fine time measurement (FTM), ultra-wideband (UWB), Bluetooth low energy (BLE), 5G new radio (NR), or 4G long term evolution (LTE). The device may also identify nearby access points (APs) (e.g., WiFi APs), base stations (BSs) (e.g., gNBs), or transmission-reception points (TRPs) (e.g., 5G TRPs) for communication of the positioning technology or RAT. For example, a device may use an identified WiFi AP or 5G TRP in order to identify a relative distance to a nearby geofence, as well as select a particular sleep duration based on the expected time to the geofence.

In some aspects, the server or network may transmit an indication of a set of parameters (e.g., device parameters) to the device. For instance, the server or network may provide the device parameters to the device (e.g., tracking device) for use along the route or route segments. The device may then set or apply the device parameters for use along the route or route segments. In one aspect, these device parameters may be loaded to the device prior to initiating a journey along the route (or route segments). Also, the device parameters may be loaded after the device has started on the route. The device parameters may also be dynamically updated along the route or route segments. The indicated parameters (e.g., device parameters, route parameters, or device-route parameters) may indicate a number of different factors or parameters to utilize along the route or route segments. For instance, the device parameters may include at least one of: assistance data (e.g., assistance data download parameters), positioning technologies (e.g., positioning technology parameters), motion parameters, sensor parameters, connectivity parameters, sleep parameters, or any combination thereof. The assistance data download parameters may include route-specific data, one or more alternative routes, global navigation satellite system (GNSS) assistance data, or a combination thereof. For example, the assistance data download parameters may include route-specific data for certain locations (e.g., WiFi AP locations, wireless/cellular base station/TRP locations, BLE locations, UWB locations (such as alternative routes or route deviation paths)). The assistance data download parameters may also include additional GNSS assistance data (e.g., precise point positioning (PPP) data, real-time kinematic (RTK) data, ephemeris data, almanac data, etc.). Moreover, the assistance data download parameters may include opportunities for additional downloads of data, which may be tied to particular geofences, time-based data, etc. The additional downloads of data may be performed at the time of device configuration, prior to device departure along the route, or at some point during the route or a particular route segment.

As indicated above, the device parameters may also include a number of positioning technology parameters or positioning method parameters. The positioning technology/method parameters may indicate which positioning technologies or methods to use for each route segment (e.g., road segment) or during the route. For example, the positioning technology/method parameters may specifically include a downlink (DL) time difference of arrival (TDOA) (DL-TDOA) for a particular positioning technology (e.g., DL-TDOA for 5G or DL-TDOA for UWB). The positioning technology/method parameters may also include an expected accuracy or an expected latency of a particular positioning technology or method. Further, the positioning technology/method parameters may include which specific parameters to use in certain circumstances (e.g., frequency bands, maximum power, etc.). Also, the positioning technology/method parameters may include a weighting scheme (e.g., a power of device), a number of fallback options, etc. In some instances, the positioning technology/method parameters may include an indication of when (or in what situations) to include waveform samples (e.g., samples from the environment around the device, samples from the environment along the route or route segments, etc.). The positioning technology/method parameters may also include an amount of locations to batch or store before reporting associated with the device.

Additionally, the device parameters may include a number of motion parameters or sensor parameters. The motion/sensor parameters may indicate a number of motion patterns that can trigger a device to perform a certain action. For example, the motion/sensor parameters may indicate a motion pattern that triggers the device to perform at least one of the following actions: wake up, go to sleep, report (e.g., report back certain information to the network/server), determine a particular location of the device along the route, or any combination thereof. The motion/sensor parameters may also indicate sensor threshold parameters that correspond to a sensor detection of a certain device function. For instance, the motion/sensor parameters may indicate when a device should report (e.g., report back certain information to the network/server), whether the device may need to record certain information and report the information opportunistically, or whether the information may need to be reported immediately. In addition, the device parameters may include a number of connectivity parameters or connection-related parameters. The connectivity parameters may indicate when a device should connect to a certain network (e.g., a time threshold, an indication of a particular road segment, a payload size minimum, or a payload size maximum). For example, the connectivity parameters may indicate a particular time or location that triggers the device to connect to a network. The connectivity parameters may also indicate whether to use a particular feature (e.g., a small data transmission (SDT) feature) while in a particular mode (e.g., a radio resource control (RRC) Inactive mode). Moreover, the connectivity parameters may indicate how to compress information to fit within a particular payload (e.g., an SDT payload). The connectivity parameters may also include a number of network synchronization parameters regarding synchronizing with a certain network (e.g., opportunities for synchronization between the device and the network, a number of synchronization thresholds to trigger for synchronization between the device and the network, etc.). Further, the device parameters may include a number of sleep parameters for the device. The sleep parameters may directly indicate a certain time when the device should go to sleep. The sleep parameters may also indicate a certain point, location, or distance at which the device should go to sleep. Also, the sleep parameters may indicate a triggering event that triggers a certain device action, such as a triggering event for sleep and/or a triggering event for waking up.

In some aspects, a server (e.g., a cloud server) may select or identify a particular route and/or route segments (e.g., road segments) for a device based on a number of expected route conditions or road conditions. Thee route segments may also be selected based on a sensitivity of cargo or packages on the device. For example, the server may identify road segments along the route with fewer potholes (compared to other road segments) based on a sensitivity of the cargo or packages that are being transported on the device. In one instance, the input to the server may directly include information regarding a cargo/package sensitivity to certain motion or vibrations. This information may be indirectly inputted to the server based on the type of cargo/package being transported (e.g., fragile items, temperature-sensitive items, medicine, etc.). Also, a server may select or identify a particular route and/or route segments based on an expected environment or environmental conditions (e.g., weather) along the route. For instance, these environmental conditions may be related to the sensitivity of cargo/packages being transported on the device. The server may also select or identify a particular route and/or route segments based on the power consumption at the device or battery conditions at the device. For example, if the device is transporting heavy cargo/packages, this may result in a high consumption of power/battery at the device, so the server may select a route or route segments based on the high consumption of power or battery power. Additionally, a server or network may indicate which device can report back on behalf of other nearby devices (e.g., transport devices or pallet devices). For instance, a server may transmit an indication to each nearby device that includes a capability of the device to report back for other nearby devices. Based on this indication, each device may report (or not report) back to the server on behalf of other nearby devices.

FIG. 7 is a diagram 700 illustrating an example route or route segments for a device 702. In some instances, the device 702 may be traveling along the route or route segments from an origin point 740 to a destination point 742. For example, the device 702 may be traveling along one or more route segments (e.g., route segment 760, route segment 761, route segment 762, route segment 763, or route segment 764) from origin point 740 to destination point 742. The device 702 may be on a moving object (e.g., a vehicle, an automobile, a boat, an airplane, etc.) or may be a tracking device on a moving object. The device 702 may be carrying one or more other devices including device 702A, device 702B, device 702C, and device 702D. For example, the devices 702A, 702B, 702C, and 702D may be cargo, packages, or items on device 702. Device 702 may be configured or preconfigured with a route or route segments that are associated with a particular motion pattern or a set of motion events (e.g., the device 702 may be configured with the route or route segments before the device 702 departs from the origin point 740). As depicted in FIG. 7, the motion pattern may include a number of route segments or an expected sequence of events that may be determined by a server (e.g., server 704 that is managing device 702) to be expected to occur while the device 702 travels from the origin point 740 to the destination point 742. The server 704 may be a number of different servers, such as a cloud server. For example, the route segments or sequence of events may include motion events that are related to certain types of movement of the device 702 (e.g., straight movement, a left turning movement, or a right turning movement). The sequence of events may include elevation changes of the device 702, such as elevating or descending, with regard to a certain level (e.g., sea level). As shown in FIG. 7, the route segments or motion pattern may include one or more events at different locations, (e.g., moving straight at point 750, a left turn at point 751, a right turn at point 752, a right turn at point 753, a left turn at point 754, and moving straight after point 754). The route segments or the sequence of events in the motion pattern may correspond to an absolute location of the device 702. As used herein, the term “absolute location” may refer to a location (e.g., in longitude, latitude, or altitude) with regard to Earth. In some aspects, different events at different locations may correspond to one or more relative positions of the device 702 (e.g., the relative positions of the device 702 may correspond to the device 702A, the device 702B, the device 702C, or the device 702D). Also, the device 702 may be configured (by a server or network) with certain information at the start of a route or route segment (e.g., from origin point 740 to destination point 742) or during a route or route segment. For example, the server or network may transmit information (e.g., small data transmission (SDT) information) that configures the device 702 based on certain route conditions (e.g., traffic conditions, road conditions, weather conditions, etc.) that may affect which route or route segment is taken by the device 702. The device 702 may be configured by a number of different servers, such as a server associated with a network or a server not associated with a network. For example, the server may be a cloud server or a third party server. Further, the server may be an edge server or an edge service associated with a software application, such as a software application running on hardware associated with a network entity (e.g., an RU, a DU, and/or a CU). The hardware associated with the network entity may be network-agnostic hardware or network-specific hardware, as well as a mix of different hardware that is network-agnostic hardware and/or network-specific hardware.

Additionally, the device 702 may be configured with information regarding a set of access points, base stations, or TRPs along the route or route segments. For example, the device 702 may be configured with information regarding TRP 706A, TRP 706B, TRP 706C, TRP 706D, and TRP 706E along the route or route segments. In some aspects, information regarding the set of access points, base stations, or TRPs along the route may be associated with a number of route segments (e.g., route segments 760, 761, 762, 763, and 764) or a set of expected motion events. For example, the device 702 may be configured with information that the device 702 may, at 734, (i) wake-up and search for TRP 706B or TRP 706C between point 752 and point 753, or (ii) wake-up and search for TRP 706D or TRP 706E between point 754 and destination point 742. As further depicted in FIG. 7, the device 702 may be configured to connect to a network or server and report certain information (e.g., an absolute or relative location) or other motion data at one or more time instances (based on a duty cycle). For example, at 736 (close to point 754), the device 702 may connect to a network or server (e.g., server 704) and report certain location information or motion information.

As depicted in FIG. 7, the device 702 may obtain an indication of one or more route segments (e.g., route segments 760, 761, 762, 763, and 764) prior to initiating movement along the route segments. For example, device 702 may receive an indication of the different route segments from server 704, which may indicate a location of each route segment with respect to other points/locations (e.g., route segment 760 is between origin point 740 and point 751, route segment 761 is between point 751 and point 752, route segment 762 is between point 752 and point 753, route segment 763 is between point 753 and point 754, route segment 764 is between point 754 and destination point 742). The route segments may be indicated to the device 702 based on a number of factors, such as points/locations, at least one geofence (e.g., an absolute or relative geofence), one or more timers, etc. Further, the server 704 may transmit a set of device parameters (e.g., device parameters 780) to the device 702. The device 702 may obtain the device parameters 780 prior to starting a journey along the route segments, as well as during the journey along the route segments. The device parameters 780 may also be dynamically updated during the journey along the route segments. The device parameters 780 may include at least one of: assistance data download parameters, positioning parameters, motion parameters, sensor parameters, connectivity parameters, or sleep parameters.

As further depicted in FIG. 7, the device 702 may include a number of sensors (e.g., sensors 712). The device 702 may configure the sensors 712 based on the set of device parameters 780 for the route segments. The device 702 may also transmit sensor-related information associated with sensors 712 to the server 704 or a network. The device 702 may also obtain an indication of different route conditions (e.g., route condition 771 on route segment 762 and/or route condition 772 on route segment 764). For instance, these route conditions may be related to an environmental condition of the route (e.g., water, a puddle, snow, ice, etc.) or a physical condition of the route (e.g., a pothole or a crack in the road). Based on the route conditions, the device 702 may update sensing data or the device parameters for the route segments. The device 702 may also transmit an indication of the updated sensing data or the updated device parameters to server 704. Device 702 may also report the information regarding route conditions to server 704. Further, device 702 may receive an indication from server 704 including a reporting capability of the device 702 for reporting back on behalf of other nearby devices. Moreover, the device 702 may wake-up and search for access points (APs), base stations, or TRPs (e.g., at 734, device 702 may wake-up and search for TRP 706B or TRP 706C between point 752 and point 753). Device 702 may use the identified AP or TRP to identify a relative distance to a nearby geofence (e.g., area 782) and select a particular sleep duration based on the expected time to the geofence (e.g., area 782). Also, device 702 may receive a warning indication from server 704 if a device location is greater than a threshold distance from a target location (e.g., geofence or area 782).

In some aspects, a server (e.g., a cloud server) may request a network (e.g., a network entity, base station, and/or network TRP) or multiple networks to monitor or track a particular device along a route or route segments. For instance, a server may transmit, to a network entity or TRP, a request to monitor one or more devices (e.g., tracking devices) along one or more route segments. The request to monitor the devices may indicate to the network to monitor/track, via sensing, a particular transport vehicle along a particular route or route segment. The transport vehicle may be number of devices, such as a moving device (e.g., a vehicle, an automobile, a boat, an airplane, etc.), a tracking device, and/or cargo/packages on a particular device. Also, a server may provide the network with information associated with a route or route segments (i.e., route information) along with device information associated with the devices. In some instances, the request to monitor may include device information associated with the devices and/or route information associated with the route or route segments. The device information may include a device identifier (ID) for each of the devices, and the route information may include a configuration of the route segments or one or more conditions of the route segments. Further, the server may indicate (e.g., indicate in the request to monitor) a number of different factors regarding the network operation during the monitoring of the devices. For example, the request to monitor may indicate a time period (i.e., a monitoring period) for monitoring the devices, a periodicity for monitoring the devices, a distance for monitoring the devices, and/or an accuracy level for monitoring the devices. In some instances, if a particular network operator does not have coverage to monitor the devices, the server can engage another network operator in order to handoff the monitoring operation (e.g., a sensing track operation) from an initial network operator to another network operator. For instance, the server may re-engage the other network operator in a similar manner to the initial network operator, such as by transmitting a request to monitor the devices. Also, the server may provide a precise position of a device, along with particular features that either identify the device (e.g., a transport vehicle) or disambiguate the device from the other nearby devices or vehicles.

In response to receiving the request to monitor the devices, the network (e.g., a network entity or TRP) may identify one or more devices (e.g., via device IDs) and perform ranging (i.e., a ranging process) with the device until the network identifies the transport device/vehicle. The ranging process may be associated with an identification of the device(s) or an identification of a position/location of the devices. The ranging process may be based on a distance of communication (i.e., ranging communication) between the device(s) and the network, a timing of communication between the device(s) and the network, and/or a signal strength of communication between the device(s) and the network. The ranging process may be associated with information (i.e., ranging information) regarding the ranging communication between the device(s) and the network. In some instances, the ranging process may be associated with determining a location of the device, which may be performed with different detection/ranging methods (e.g., light detection and ranging (LiDAR) or radio detection and ranging (RADAR)). Also, the network may identify the transport devices/vehicles via sensing or a sensing process. The network may also identify the transport devices/vehicles based on the ranging information from the ranging process. The network may then transmit to the server (and the server may receive from the network) an indication of a monitoring status regarding the devices. For instance, the server may receive an indication of when a network (e.g., a network TRP) has detected the device(s) and is tracking the device(s) (e.g., the transport vehicle). The server may also update the device information and/or the route information associated with the route segments. For example, the server may notify device(s) on the transport vehicle of the updated device information or the updated route information. The updated device information may include an updated reporting schedule and/or an updated sleep schedule for the devices, and the updated route information may include one or more triggering events along the route segments for the devices. For example, device may be triggered by a certain event (e.g., a device on a flight may be triggered by a landing) to report information in order to determine a location. In some instances, the device may wait for a certain period/distance (e.g., until the device has stopped moving) to report the information.

After performing the ranging process and transmitting an indication of a monitoring status regarding the devices, the network may monitor or track the device/vehicle along the route or route segments. For instance, each network entity (e.g., TRP/AP/base station) in the network along the route (e.g., within a certain proximity or distance of the route) may continue monitoring or tracking the vehicle as it moves along the route or route segments. The network entity (e.g., TRP/AP/base station) that detects and tracks the vehicle may notify a nearby network entity to handoff tracking of the vehicle. In some instances, dead zones (i.e., areas in which a network entity does not have any coverage to track the vehicle) along the route may correspond to areas in which the tracking device performs its own positioning (i.e., the dead zones may be “filled in” by the device performing positioning). The route or route segments may also include a number drop points or drop off events (i.e., an event where cargo/packages on the device are dropped off at a particular point (“the drop point”)). At each drop point along the route, certain devices (e.g., tracking devices) may include a corresponding motion that equates to leaving the transport device (i.e., being dropped off the transport device). The transport device (or the devices that are dropped off) may wake-up and report the drop off event (if configured to report this drop off event). Also, devices (e.g., tracking devices) may batch or store sensor measurements or other relevant information regarding the location/movement of the device along the route or route segments. This may occur even though at least some of the location/movement tracking may be offloaded to the network.

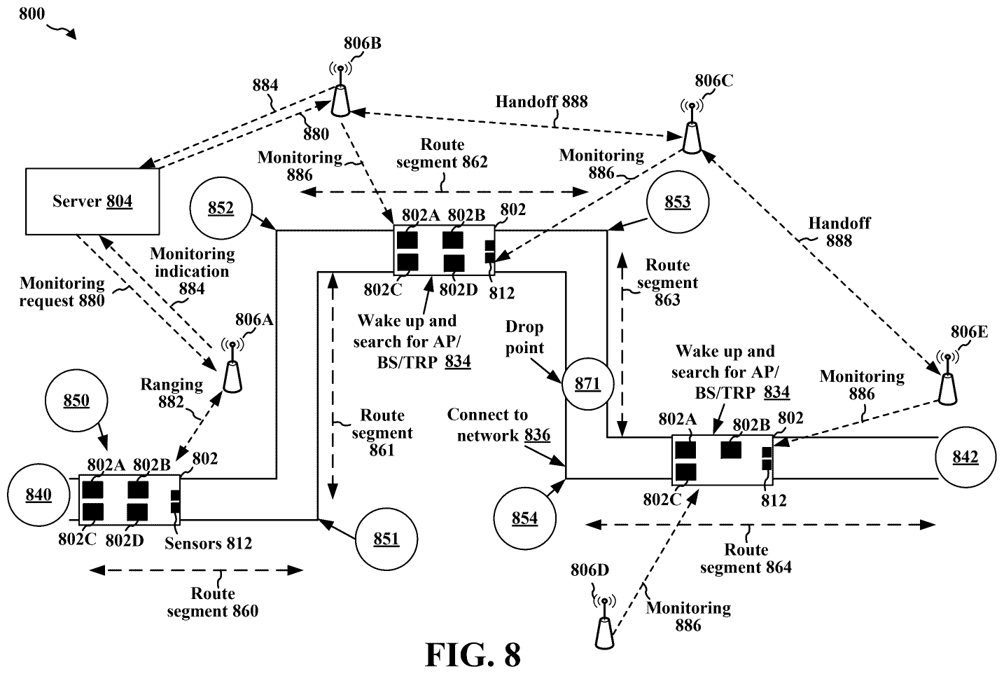

FIG. 8 is a diagram 800 illustrating an example route or route segments for a device 802. In some instances, the device 802 may be traveling along the route or route segments from an origin point 840 to a destination point 842. For example, the device 802 may be traveling along one or more route segments (e.g., route segment 860, route segment 861, route segment 862, route segment 863, and route segment 864) from origin point 840 to destination point 842. The device 802 may be on a moving object (e.g., a vehicle, an automobile, a boat, an airplane, etc.) or may be a tracking device on a moving object. The device 802 may be carrying one or more other devices including device 802A, device 802B, device 802C, and device 802D. For example, the devices 802A, 802B, 802C, and 802D may be cargo, packages, or items on device 802. Similar to device 702 in FIG. 7, device 802 may be configured or preconfigured with a route or route segments that are associated with a particular motion pattern or a set of motion events (e.g., the device 802 may be configured with the route or route segments before the device 802 departs from the origin point 840). As depicted in FIG. 8, the motion pattern may include a number of route segments or an expected sequence of events that may be determined by a server (e.g., server 804 that is managing the device 802) to be expected to occur while the device 802 travels from the origin point 840 to the destination point 842. The server 804 may be a number of different servers, such as a cloud server. As shown in FIG. 8, the route segments or motion pattern may include one or more events at different locations (e.g., moving straight at point 850, a left turn at point 851, a right turn at point 852, a right turn at point 853, a left turn at point 854, and moving straight after point 854). Additionally, the device 802 may be configured with information regarding a set of access points, base stations, or TRPs along the route or route segments. For example, the device 802 may be configured with information regarding TRP 806A, TRP 806B, TRP 806C, TRP 806D, and TRP 806E along the route or route segments. In some aspects, information regarding the set of access points, base stations, or TRPs along the route may be associated with a number of route segments (e.g., route segments 860, 861, 862, 863, and 864) or a set of expected motion events. For example, the device 802 may be configured with information that the device 802 may, at 834, (i) wake-up and search for TRP 806B or TRP 806C between point 852 and point 853, or (ii) wake-up and search for TRP 806D or TRP 806E between point 854 and destination point 842. As further depicted in FIG. 8, the device 802 may be configured to connect to a network or server and report certain information or other motion data at one or more time instances. For example, at 836 (near point 854), the device 802 may connect to a network or server (e.g., server 804) and report certain location/movement information. The device 802 may also include a number of sensors (e.g., sensors 812), and the device 802 may transmit sensor-related information associated with sensors 812 to the server 804 or a network. Also, the device 802 may be configured (by a server or network) with certain information at the start of a route or route segment (e.g., from origin point 840 to destination point 842) or during a route or route segment. For example, the server or network may transmit information (e.g., small data transmission (SDT) information) that configures the device 802 based on certain route conditions (e.g., traffic conditions, road conditions, weather conditions, etc.) that may affect which route or route segment is taken by the device 802. The device 802 may be configured by a number of different servers, such as a server associated with a network or a server not associated with a network. For example, the server may be a cloud server or a third party server. Further, the server may be an edge server or an edge service associated with a software application, such as a software application running on hardware associated with a network entity (e.g., an RU, a DU, and/or a CU). The hardware associated with the network entity may be network-agnostic hardware or network-specific hardware, as well as a mix of different hardware that is network-agnostic hardware and/or network-specific hardware.

As depicted in FIG. 8, the server 804 may transmit a monitoring request 880 to a network entity (e.g., TRP 806A, TRP 806B, TRP 806C, TRP 806D, and TRP 806E) along the route of device 802. The monitoring request 880 may be a request to monitor device 802 along one or more route segments (e.g., route segments 860, 861, 862, 863, and 864). In response to receiving the monitoring request 880, the network (e.g., TRP 806A or TRP 806B) may verify an identifier (e.g., a device ID) for the device 802 and perform ranging 882 (i.e., a ranging process) with the device 802 until the network identifies the device 802. As indicated above, the ranging 882 may be associated with an identification of the device 802 or a position/location of the device 802. The ranging 882 may be based on a distance of communication between the device 802 and the TRP 806A, a timing of communication between the device 802 and the TRP 806A, or a signal strength of communication between the device 802 and the TRP 806A. After the ranging 882, the network (e.g., TRP 806A or TRP 806B) may transmit a monitoring indication 884 (an indication of a monitoring status regarding the device 802) to the server 804. For instance, the server 804 may receive monitoring indication 884 regarding when the TRP 806A or TRP 806B has detected device 802 and is tracking the device 802. Each of the TRPs in the network (TRP 806A, TRP 806B, TRP 806C, TRP 806D, and TRP 806E) may continue to monitor (via monitoring 886) device 802 along the route or route segments. Further, as the device 802 moves along the route or route segments, each of the TRPs in the network (TRP 806A, TRP 806B, TRP 806C, TRP 806D, and TRP 806E) may handoff (via handoff 888) the monitoring to another TRP along the route. Also, route segment 863 may include a drop point 871 where a certain device/cargo/packages (e.g., device 802D) on the device 802 is dropped off at a particular point (e.g., the drop point 871). After the drop point 871, device 802 and/or device 802D may wake-up and report the drop off event. As shown in FIG. 8, after the drop point 871, the device 802 may no longer include device 802D (as it was previously dropped off).

In some aspects, a server and/or a device may utilize the density of network entities (e.g., APs/BSs/TRPs) in order to determine whether to use a certain positioning technology along a particular route section. For example, a server and/or a device may utilize density information related to certain devices (e.g., WiFi APs, cellular/wireless base stations, BLE network entities, UWB network entities) to determine whether to use corresponding positioning technology along a part of the route. Also, a server/device may determine to stop using a certain technology (e.g., GNSS) and switch to a different positioning technology, such as by utilizing density information of the different positioning technology. The server/device may explicitly determine on which part of a route or route segment to utilize the different positioning technologies. In some instances, a server/device may utilize the capability (e.g., capability type) of base stations (e.g., cellular base stations), TRPs, or APs (e.g., WiFi APs) in a certain area to determine whether to use the corresponding technology instead of an initial technology or methodology (e.g., GNSS). The server/device may also indicate whether to use a specific type of a particular technology (e.g., GPS-only GNSS, etc.). In some instances, a certain technology may include a capability for different positioning types or frequency types. For example, a WiFi capability may include certain positioning types (e.g., WiFi received signal strength indicator (RSSI) or WiFi fine time measurement (FTM)) and/or certain frequency types (e.g., 2.4 GHz, 5 GHz, 6 GHz, 60 GHz, etc.). The capability for different positioning technologies may also include whether the technology is open and available, or whether the technology needs an authentication process (e.g., whether WiFi is open and available, or whether WiFi needs authentication). The server/device may also indicate whether to use a certain technology based on a reliability of corresponding network entities (e.g., APs/BSs/TRPs) in an area (e.g., a number of times the network entities have been crowdsourced, one or more recent measurements, etc.).

Additionally, a server and/or device may utilize sensor information during the position location process along the route or route segments. For instance, a server and/or device may obtain sensor information (e.g., sensor drift information) to determine an accurate position of the device. This sensor information may also be combined with other signals/communication and/or database information (e.g., a database of the potential positions, position range, etc.). For example, the server may have a database of position information for the device (e.g., WiFi position data), and the sensor information from the device may be used to adjust/shift the position information. Also, the server may receive the sensor information from the device and compare this information to other information (e.g., database information). The server may also instruct the device to adjust the use of sensor information along the route or route segments.

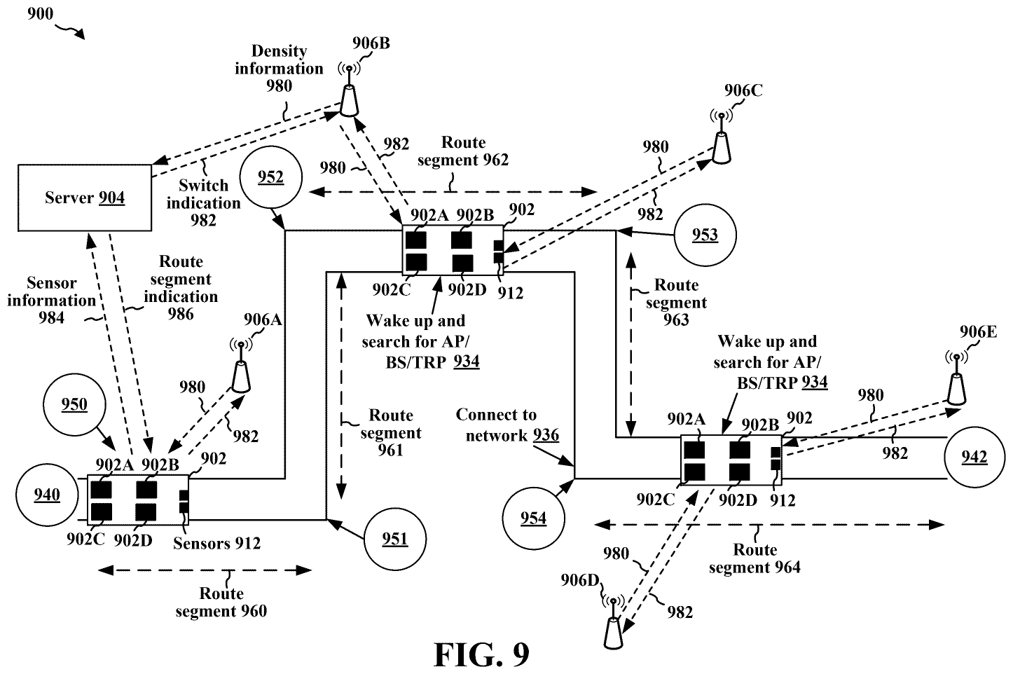

FIG. 9 is a diagram 900 illustrating an example route or route segments for a device 902. In some instances, the device 902 may be traveling along the route or route segments from an origin point 940 to a destination point 942. For example, the device 902 may be traveling along one or more route segments (e.g., route segment 960, route segment 961, route segment 962, route segment 963, and route segment 964) from origin point 940 to destination point 942. The device 902 may be on a moving object (e.g., a vehicle, an automobile, a boat, an airplane, etc.) or may be a tracking device on a moving object. The device 902 may be carrying one or more other devices including device 902A, device 902B, device 902C, and device 902D. For example, the devices 902A, 902B, 902C, and 902D may be cargo, packages, or items on device 902. Similar to device 702 in FIG. 7 and device 802 in FIG. 8, device 902 may be configured or preconfigured with a route or route segments that are associated with a particular motion pattern or a set of motion events (e.g., the device 902 may be configured with the route or route segments before the device 902 departs from the origin point 940). As depicted in FIG. 9, the motion pattern may include a number of route segments or an expected sequence of events that may be determined by a server (e.g., server 904 that is managing the device 902) to be expected to occur while the device 902 travels from the origin point 940 to the destination point 942. The server 904 may be a number of different servers, such as a cloud server. As shown in FIG. 9, the route segments or motion pattern may include one or more events at different locations, (e.g., moving straight at point 950, a left turn at point 951, a right turn at point 952, a right turn at point 953, a left turn at point 954, and moving straight after point 954). Additionally, the device 902 may be configured with information regarding a set of access points, base stations, or TRPs along the route or route segments. For example, the device 902 may be configured with information regarding TRP 906A, TRP 906B, TRP 906C, TRP 906D, and TRP 906E along the route or route segments. In some aspects, information regarding the set of access points, base stations, or TRPs along the route may be associated with a number of route segments (e.g., route segments 960, 961, 962, 963, and 964) or a set of expected motion events. For example, the device 902 may be configured with information that the device 902 may, at 934, (i) wake-up and search for TRP 906B or TRP 906C between point 952 and point 953, or (ii) wake-up and search for TRP 906D or TRP 906E between point 954 and destination point 942. As further depicted in FIG. 9, the device 902 may be configured to connect to a network or server and report certain information or other motion data at one or more time instances. For example, at 936 (near point 954), the device 902 may connect to a network or server (e.g., server 904) and report certain location/movement information. The device 902 may also include a number of sensors (e.g., sensors 912), and the device 902 may transmit sensor-related information associated with sensors 912 to the server 904 or a network. Also, the device 902 may be configured (by a server or network) with certain information at the start of a route or route segment (e.g., from origin point 940 to destination point 942) or during a route or route segment. For example, the server or network may transmit information (e.g., small data transmission (SDT) information) that configures the device 902 based on certain route conditions (e.g., traffic conditions, road conditions, weather conditions, etc.) that may affect which route or route segment is taken by the device 902. The device 902 may be configured by a number of different servers, such as a server associated with a network or a server not associated with a network. For example, the server may be a cloud server or a third party server. Further, the server may be an edge server or an edge service associated with a software application, such as a software application running on hardware associated with a network entity (e.g., an RU, a DU, and/or a CU). The hardware associated with the network entity may be network-agnostic hardware or network-specific hardware, as well as a mix of different hardware that is network-agnostic hardware and/or network-specific hardware.

As depicted in FIG. 9, the device 902 may obtain density information 980 from TRP 906A (or any other TRP). Also, the server 904 may obtain density information 980 from TRP 906B (or any other TRP). The density information 980 may be associated with a set of network entities (e.g., TRP 906A, TRP 906B, TRP 906C, TRP 906D, and TRP 906E) along the route or route segments (e.g., route segments 960, 961, 962, 963, and 964). The device 902 and/or server 904 may determine whether to switch from a first positioning technology (e.g., GNSS) to a second positioning technology (e.g., WiFi) along the route or route segments (e.g., route segments 960, 961, 962, 963, and 964) based on the density information associated with the set of network entities. The determination whether to switch from the first positioning technology to the second positioning technology may be based on a capability of each of the network entities or a reliability of each of the network entities. After this determination, the device 902 and/or server 904 may transmit a switch indication 982 (i.e., an indication of the determination whether to switch from the first positioning technology to the second positioning technology along the one or more route segments) to the TRP 906A or TRP 906B (or any other TRPs). In some instances, the first positioning technology may be global navigation satellite system (GNSS), and the second positioning technology may be WiFi, WiFi received signal strength indicator (RSSI), WiFi fine time measurement (FTM), ultra-wideband (UWB), Bluetooth low energy (BLE), 5G new radio (NR), or 4G long term evolution (LTE). As shown in FIG. 9, the device 902 may also transmit sensor information 984 (i.e., sensor-related information associated with sensors 912) to the server 904. Also, server 904 may transmit, to device 902, a route segment indication 986 associated with the switch in positioning technologies. Likewise, device 902 may receive route segment indication 986 from server 904. For example, route segment indication 986 may be an indication of the route segments associated with the switch from the first positioning technology to the second positioning technology.

In some aspects, a server may determine whether a device is in a certain type of location (e.g., a rural, a suburban location, or an urban location). This location determination may be based on a density of network entities in an area (e.g., a density of WiFi APs or cellular/wireless BSs/TRPs). A server may also determine a sleep schedule for a device and/or communication periods for the device based on an identification of a sparsity of a network connectivity (e.g., a rural/urban environment determination). The identification of the sparsity of a network connectivity may include a fallback indication regarding whether to fallback to a certain connectivity (e.g., satellite-based connectivity). Further, a server may determine or predict the fallback to the certain connectivity (e.g., satellite-based connectivity). Also, a server may determine a sleep schedule for a device and/or communication periods for the device based on a density of network entities in an area (e.g., a density of WiFi APs or cellular/wireless BSs/TRPs). For example, a server may transmit, to a device, a location status indication (i.e., an indication of the location status of the device). After this, the server may select/determine a sleep schedule for the device or a communication period for the device based on the density information or the location status of the device. The server may then transmit, to the device, an indication of the sleep schedule for the device or the communication period for the device. In some instances, different sections of the route segments may correspond to different environments, which may be determined based on density information. For example, a first route segment may correspond to a first environment (e.g., a rural environment or a suburban environment), a second route segment may correspond to a second environment (e.g., a dense urban environment), and a third route segment may correspond to a third environment (e.g., a rural environment or a suburban environment).

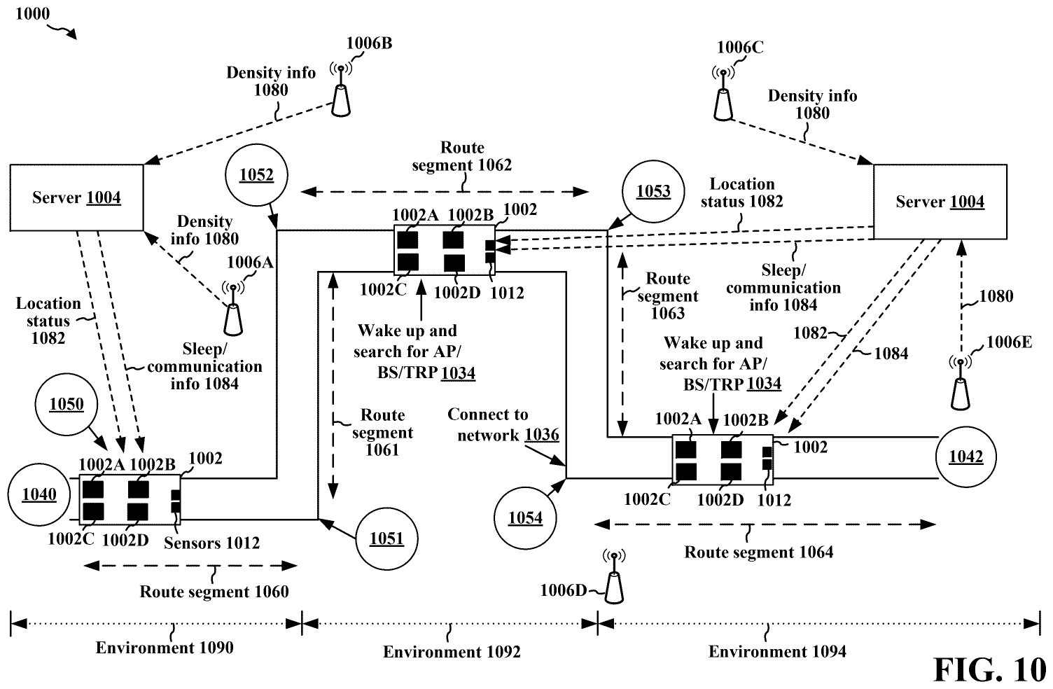

FIG. 10 is a diagram 1000 illustrating an example route or route segments for a device 1002. In some instances, the device 1002 may be traveling along the route or route segments from an origin point 1040 to a destination point 1042. For example, the device 1002 may be traveling along one or more route segments (e.g., route segment 1060, route segment 1061, route segment 1062, route segment 1063, and route segment 1064) from origin point 1040 to destination point 1042. The device 1002 may be on a moving object (e.g., a vehicle, an automobile, a boat, an airplane, etc.) or may be a tracking device on a moving object. The device 1002 may be carrying one or more other devices including device 1002A, device 1002B, device 1002C, and device 1002D. For example, the devices 1002A, 1002B, 1002C, and 1002D may be cargo, packages, or items on device 1002. Similar to device 702 in FIG. 7, device 802 in FIG. 8, and device 902 in FIG. 9, device 1002 may be configured or preconfigured with a route or route segments that are associated with a particular motion pattern or a set of motion events (e.g., the device 1002 may be configured with the route or route segments before the device 1002 departs from the origin point 1040). As depicted in FIG. 10, the motion pattern may include a number of route segments or an expected sequence of events that may be determined by a server (e.g., server 1004 that is managing the device 1002) to be expected to occur while the device 1002 travels from the origin point 1040 to the destination point 1042. The server 1004 may be a number of different servers, such as a cloud server. As shown in FIG. 10, the route segments or motion pattern may include one or more events at different locations, (e.g., moving straight at point 1050, a left turn at point 1051, a right turn at point 1052, a right turn at point 1053, a left turn at point 1054, and moving straight after point 1054). Additionally, the device 1002 may be configured with information regarding a set of access points, base stations, or TRPs along the route or route segments. For example, the device 1002 may be configured with information regarding TRP 1006A, TRP 1006B, TRP 1006C, TRP 1006D, and TRP 1006E along the route or route segments. In some aspects, information regarding the set of access points, base stations, or TRPs along the route may be associated with a number of route segments (e.g., route segments 1060, 1061, 1062, 1063, and 1064) or a set of expected motion events. For example, the device 1002 may be configured with information that the device 1002 may, at 1034, (i) wake-up and search for TRP 1006B or TRP 1006C between point 1052 and point 1053, or (ii) wake-up and search for TRP 1006D or TRP 1006E between point 1054 and destination point 1042. As further depicted in FIG. 10, the device 1002 may be configured to connect to a network or server and report certain information or other motion data at one or more time instances. For example, at 1036 near point 1054, the device 1002 may connect to a network or server (e.g., server 1004) and report certain location/movement information. The device 1002 may also include a number of sensors (e.g., sensors 1012), and the device 1002 may transmit sensor-related information associated with sensors 1012 to the server 1004 or a network. Also, the device 1002 may be configured (by a server or network) with certain information at the start of a route or route segment (e.g., from origin point 1040 to destination point 1042) or during a route or route segment. For example, the server or network may transmit information (e.g., small data transmission (SDT) information) that configures the device 1002 based on certain route conditions (e.g., traffic conditions, road conditions, weather conditions, etc.) that may affect which route or route segment is taken by the device 1002. The device 1002 may be configured by a number of different servers, such as a server associated with a network or a server not associated with a network. For example, the server may be a cloud server or a third party server. Further, the server may be an edge server or an edge service associated with a software application, such as a software application running on hardware associated with a network entity (e.g., an RU, a DU, and/or a CU). The hardware associated with the network entity may be network-agnostic hardware or network-specific hardware, as well as a mix of different hardware that is network-agnostic hardware and/or network-specific hardware.

As depicted in FIG. 10, the server 1004 may receive/obtain density information 1080 from a network entity (e.g., TRP 1006A, TRP 1006B, TRP 1006C, TRP 1006D, and TRP 1006E). The density information may be associated with a set of network entities (e.g., TRPs) along the route segments (e.g., route segments 1060, 1061, 1062, 1063, and 1064). The server 1004 may then determine a location status of the device 1002 based on the density information 1080. The location status of device 1002 may correspond to a certain type of location (e.g., a rural location, a suburban location, or an urban location). The server 1004 may then transmit, to device 1002, location status indication 1082 (i.e., an indication of the location status of the device 1002). Likewise, the device 1002 may receive location status indication 1082 from server 1004. After this, the server 1004 may select/determine a sleep schedule for the device 1002 or a communication period for the device 1002 based on the density information 1080 or the location status of the device 1002. The server 1004 may then transmit, to the device 1002, an indication 1084 of the sleep schedule for the device 1002 or the communication period for the device 1002. Likewise, the device 1002 may receive indication 1084. As further shown in FIG. 10, different sections of the route segments (e.g., route segments 1060, 1061, 1062, 1063, and 1064) may correspond to a different environment, which may be determined based on density information 1080. For example, route segment 1060 may correspond to environment 1090 (e.g., a suburban environment), route segments 1061, 1062, and 1063 may correspond to environment 1092 (e.g., an urban environment), and route segment 1064 may correspond to environment 1094 (e.g., a suburban environment).

Aspects of the present disclosure may include a number of benefits or advantages. For instance, aspects presented herein may improve the power consumption of devices in navigation systems or position location systems. That is, aspects presented herein may lower the power consumption of devices by indicating the suitable or desired methodologies for determining the positioning of each device. For instance, devices herein may receive an indication of a suitable or desired methodology for determining the positioning of each device when the devices are in a particular route segment (e.g., road segment). Additionally, prior to a route or a particular route segment, devices herein may be preconfigured with the positioning technologies to utilize in certain environments (e.g., a dense urban environment or a rural environment) or certain route sections. By doing so, devices herein may utilize a reduced amount of battery/power consumption, as they may not need to be prompted to change a QoS or a positioning technology in certain scenarios.

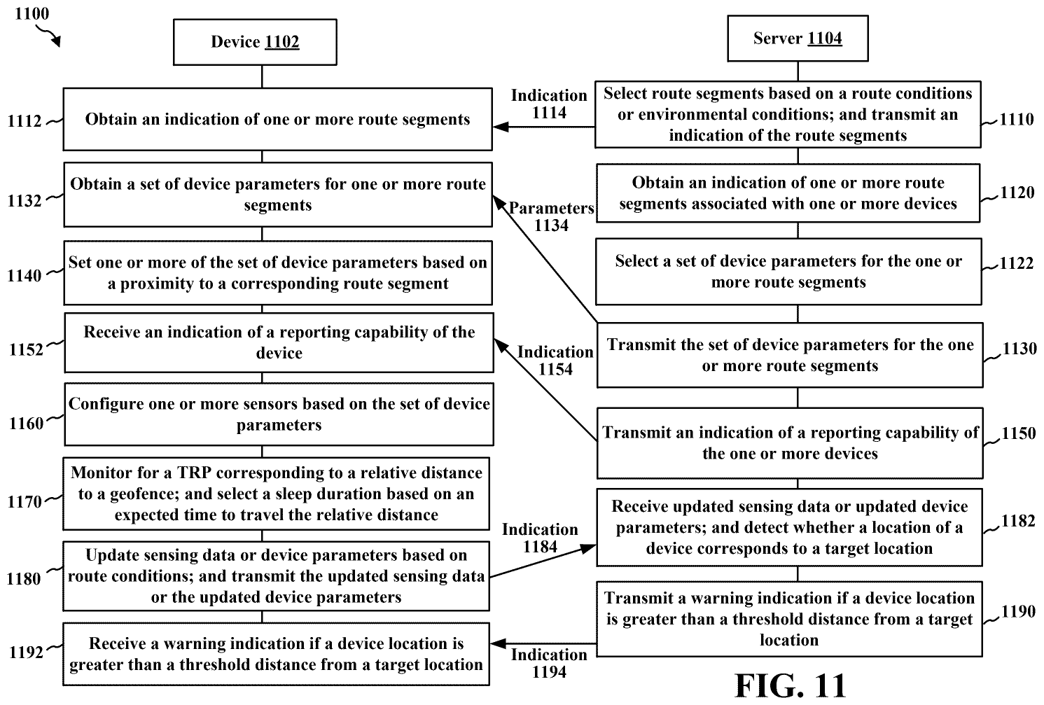

FIG. 11 is a communication flow diagram 1100 of wireless communication in accordance with one or more techniques of this disclosure. As shown in FIG. 11, diagram 1100 includes example communications between device 1102 (e.g., a wireless device or UE) and server 1104 (e.g., a cloud server, a third party server, an edge server, a network, or a network entity), in accordance with one or more techniques of this disclosure. In some aspects, device 1102 may be a first wireless device (e.g., UE, base station, TRP, server, or network entity) and server 1104 may be a second wireless device (e.g., UE, base station, TRP, server, or network entity).

At 1110, server 1104 may select one or more route segments based on a set of route conditions or a set of environmental conditions associated with the one or more route segments; and transmit a second indication (e.g., indication 1114) of the selected one or more route segments. The one or more route segments may be based on at least one of: an absolute geofence, a relative geofence, one or more timers, or a combination thereof. The set of route conditions may include at least one of a set of expected road conditions or a power status of the one or more devices, and the set of environmental conditions may include a set of expected environmental conditions associated with the one or more route segments. The one or more route segments may be based on at least one of sensor data associated with the one or more devices, a package type of at least one transport object of the one or more devices, a sensitivity of the at least one transport object of the one or more devices, or a combination thereof. At 1112, device 1102 may obtain an indication (e.g., indication 1114) of one or more route segments prior to obtaining a set of device parameters, where the indication is obtained based on at least one of: information from at least one external source, information from at least one internal source, information from a database, a machine learning (ML) model, a neural network (NN) model, or a combination thereof. The one or more route segments may be associated with at least one route with a plurality of points including an origin point and a destination point, where the at least one route includes a plurality of routes, where each route of the plurality of routes corresponds to a different route from the origin point to the destination point, and where the plurality of routes includes at least one of a multimodal route, an intermodal route, or an intramodal route. Also, the device may be included in a plurality of devices, and each route of the at least one route may apply to each corresponding device of the plurality of devices.

At 1120, server 1104 may obtain an indication of one or more route segments associated with one or more devices. The one or more route segments may be associated with at least one route with a plurality of points including an origin point and a destination point, where the at least one route includes a plurality of routes, where each route of the plurality of routes may correspond to a different route from the origin point to the destination point, and where the plurality of routes includes at least one of a multimodal route, an intermodal route, or an intramodal route. The one or more devices may include a plurality of devices, where each route of the at least one route applies to each corresponding device of the plurality of devices, and where the indication may be obtained based on at least one of: information from at least one external source, information from at least one internal source, information from a database, a machine learning (ML) model, a neural network (NN) model, or a combination thereof.

At 1122, server 1104 may select a set of device parameters for the one or more route segments, where the set of device parameters for the one or more route segments includes an indication of an operation of the one or more devices along each of the one or more route segments, where one or more device parameters of the set of device parameters are based on a proximity of the one or more devices to a corresponding route segment of the one or more route segments. The set of device parameters may include at least one of: one or more assistance data download parameters, one or more positioning parameters, one or more motion parameters, one or more sensor parameters, one or more connectivity parameters, one or more sleep parameters, or a combination thereof. The one or more assistance data download parameters may include at least one of: route-specific data, one or more alternative routes, global navigation satellite system (GNSS) assistance data, or a combination thereof. The one or more positioning parameters may include at least one of: an indication of positioning technologies for each of the one or more route segments, an expected accuracy of the one or more positioning parameters, an expected latency of the one or more positioning parameters, a weighting scheme of the one or more positioning parameters, one or more fallback options associated with the one or more positioning parameters, one or more situations for waveform samples associated with the one or more positioning parameters, one or more locations to batch prior to reporting the set of device parameters, or a combination thereof. The one or more motion parameters may indicate one or more motion patterns for triggering at least one of: a wake-up time, a sleep time, a report time, a location determination, or a combination thereof. The one or more sensor parameters may indicate one or more sensor threshold parameters for device reporting, a reporting time for the device, a reporting period for the device, or a combination thereof. The one or more connectivity parameters may indicate at least one of: a connection time for the device to connect with a network, a small data transmission (SDT) feature for at least one device mode, a compression for an SDT payload, or a combination thereof. The one or more sleep parameters may indicate at least one of: the sleep time, a sleep triggering event, a wake-up triggering event, or a combination thereof.

At 1130, server 1104 may transmit the set of device parameters (e.g., parameters 1134) for the one or more route segments to the one or more devices.

At 1132, device 1102 may obtain a set of device parameters (e.g., parameters 1134) for one or more route segments from a server, where the set of device parameters for the one or more route segments includes an indication of an operation of the device along each of the one or more route segments. The set of device parameters may include at least one of: one or more assistance data download parameters, one or more positioning parameters, one or more motion parameters, one or more sensor parameters, one or more connectivity parameters, one or more sleep parameters, or a combination thereof. The one or more assistance data download parameters may include at least one of: route-specific data, one or more alternative routes, global navigation satellite system (GNSS) assistance data, or a combination thereof. The one or more positioning parameters may include at least one of: an indication of positioning technologies for each of the one or more route segments, an expected accuracy of the one or more positioning parameters, an expected latency of the one or more positioning parameters, a weighting scheme of the one or more positioning parameters, one or more fallback options associated with the one or more positioning parameters, one or more situations for waveform samples associated with the one or more positioning parameters, one or more locations to batch prior to reporting the set of device parameters, or a combination thereof. The one or more motion parameters may indicate one or more motion patterns for triggering at least one of: a wake-up time, a sleep time, a report time, a location determination, or a combination thereof. The one or more sensor parameters may indicate one or more sensor threshold parameters for device reporting, a reporting time for the device, a reporting period for the device, or a combination thereof. The one or more connectivity parameters may indicate at least one of: a connection time for the device to connect with a network, a small data transmission (SDT) feature for at least one device mode, a compression for an SDT payload, or a combination thereof. The one or more sleep parameters may indicate at least one of: the sleep time, a sleep triggering event, a wake-up triggering event, or a combination thereof.

At 1140, device 1102 may set one or more device parameters of the set of device parameters for the one or more route segments based on a proximity of the device to a corresponding route segment of the one or more route segments. The one or more device parameters may be set prior to a movement of the device along the one or more route segments, or the one or more device parameters may be set dynamically during the one or more route segments. The one or more route segments may be based on a set of route conditions or a set of environmental conditions associated with the one or more route segments. The set of route conditions may include at least one of a set of expected road conditions or a power status of the device, and the set of environmental conditions may include a set of expected environmental conditions associated with the one or more route segments. The one or more route segments may be based on at least one of sensor data associated with the device, a package type of at least one transport object of the device, a sensitivity of the at least one transport object of the device, or a combination thereof.

At 1150, server 1104 may transmit an indication (e.g., indication 1154) of a reporting capability of each of the one or more devices, where the reporting capability indicates whether each of the one or more devices includes a capability to report on behalf of one or more additional devices.

At 1152, device 1102 may receive an indication (e.g., indication 1154) of a reporting capability of the device, where the reporting capability indicates whether the device includes a capability to report on behalf of one or more additional devices.

At 1160, device 1102 may configure one or more sensors of the device based on the set of device parameters for the one or more route segments. The one or more route segments may be based on at least one of: an absolute geofence, a relative geofence, one or more timers, or a combination thereof.

At 1170, device 1102 may monitor for at least one transmission-reception point (TRP) corresponding to a relative distance to at least one other geofence associated with the absolute geofence or the relative geofence; and select a sleep duration based on an expected time to travel the relative distance to the at least one other geofence.

At 1180, device 1102 may update at least one of sensing data or the set of device parameters for the one or more route segments based on one or more route conditions along the one or more route segments; and transmit a second indication (e.g., indication 1184) of at least one of the updated sensing data or the updated set of device parameters, where the second indication is transmitted to the server.

At 1182, server 1104 may receive a second indication (e.g., indication 1184) of at least one of updated sensing data or an updated set of device parameters; and detect whether a location of the one or more devices corresponds to a list of target locations for the one or more route segments based on at least one of the updated sensing data or the updated set of device parameters.

At 1190, server 1104 may transmit a warning indication (e.g., indication 1194) to at least one device of the one or more devices if the location of the at least one device is greater than a threshold distance from at least one of the list of target locations for the one or more route segments.

At 1192, device 1102 may receive a warning indication (e.g., indication 1194) from the server if a location of the device is greater than a threshold distance from at least one of a list of target locations for the one or more route segments, where the location of the device is based on the updated sensing data or the updated set of device parameters.

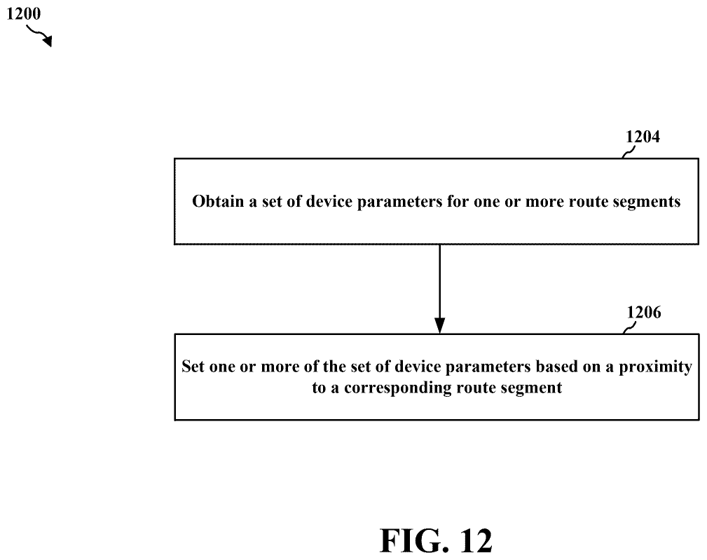

FIG. 12 is a flowchart 1200 of a method of wireless communication. The method may be performed by a device or a UE (e.g., the UE 104, device 702, device 802, device 902, device 1002, device 1102; the apparatus 1604). The methods described herein may provide a number of benefits, such as improving resource utilization and/or power savings.

At 1204, the device may obtain a set of device parameters for one or more route segments from a server (e.g., a cloud server, a third party server, an edge server, a network, or a network entity), where the set of device parameters for the one or more route segments includes an indication of an operation of the device along each of the one or more route segments, as discussed with respect to FIGS. 4-11. For example, as described in 1132 of FIG. 11, the device 1102 may obtain a set of device parameters for one or more route segments from a server, where the set of device parameters for the one or more route segments includes an indication of an operation of the device along each of the one or more route segments. Further, step 1204 may be performed by parameter component 198. The set of device parameters may include at least one of: one or more assistance data download parameters, one or more positioning parameters, one or more motion parameters, one or more sensor parameters, one or more connectivity parameters, one or more sleep parameters, or a combination thereof. The one or more assistance data download parameters may include at least one of: route-specific data, one or more alternative routes, global navigation satellite system (GNSS) assistance data, or a combination thereof. The one or more positioning parameters may include at least one of: an indication of positioning technologies for each of the one or more route segments, an expected accuracy of the one or more positioning parameters, an expected latency of the one or more positioning parameters, a weighting scheme of the one or more positioning parameters, one or more fallback options associated with the one or more positioning parameters, one or more situations for waveform samples associated with the one or more positioning parameters, one or more locations to batch prior to reporting the set of device parameters, or a combination thereof. The one or more motion parameters may indicate one or more motion patterns for triggering at least one of: a wake-up time, a sleep time, a report time, a location determination, or a combination thereof. The one or more sensor parameters may indicate one or more sensor threshold parameters for device reporting, a reporting time for the device, a reporting period for the device, or a combination thereof. The one or more connectivity parameters may indicate at least one of: a connection time for the device to connect with a network, a small data transmission (SDT) feature for at least one device mode, a compression for an SDT payload, or a combination thereof. The one or more sleep parameters may indicate at least one of: the sleep time, a sleep triggering event, a wake-up triggering event, or a combination thereof.

At 1206, the device may set one or more device parameters of the set of device parameters for the one or more route segments based on a proximity of the device to a corresponding route segment of the one or more route segments, as discussed with respect to FIGS. 4-11. For example, as described in 1140 of FIG. 11, the device 1102 may set one or more device parameters of the set of device parameters for the one or more route segments based on a proximity of the device to a corresponding route segment of the one or more route segments. Further, step 1206 may be performed by parameter component 198. The one or more device parameters may be set prior to a movement of the device along the one or more route segments, or the one or more device parameters may be set dynamically during the one or more route segments. The one or more route segments may be based on a set of route conditions or a set of environmental conditions associated with the one or more route segments. The set of route conditions may include at least one of a set of expected road conditions or a power status of the device, and the set of environmental conditions may include a set of expected environmental conditions associated with the one or more route segments. The one or more route segments may be based on at least one of sensor data associated with the device, a package type of at least one transport object of the device, a sensitivity of the at least one transport object of the device, or a combination thereof.

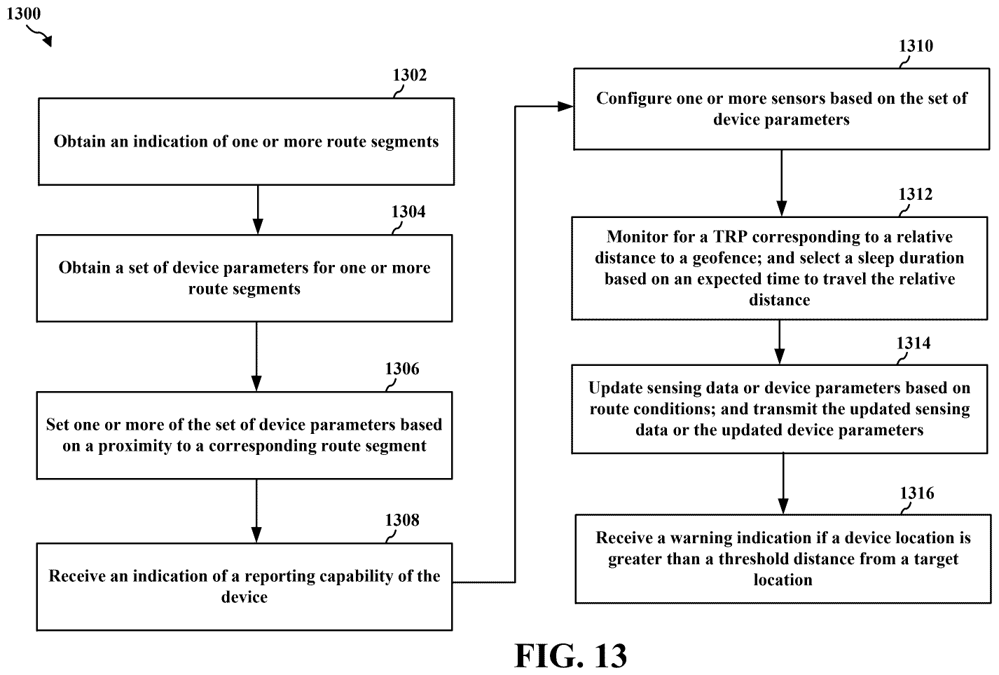

FIG. 13 is a flowchart 1300 of a method of wireless communication. The method may be performed by a device or a UE (e.g., the UE 104, device 702, device 802, device 902, device 1002, device 1102; the apparatus 1604). The methods described herein may provide a number of benefits, such as improving resource utilization and/or power savings.

At 1302, the device may obtain an indication of one or more route segments prior to obtaining a set of device parameters, where the indication is obtained based on at least one of: information from at least one external source, information from at least one internal source, information from a database, a machine learning (ML) model, a neural network (NN) model, or a combination thereof, as discussed with respect to FIGS. 4-11. For example, as described in 1112 of FIG. 11, the device 1102 may obtain an indication of one or more route segments prior to obtaining a set of device parameters, where the indication is obtained based on at least one of: information from at least one external source, information from at least one internal source, information from a database, a machine learning (ML) model, a neural network (NN) model, or a combination thereof. Further, step 1302 may be performed by parameter component 198. The one or more route segments may be associated with at least one route with a plurality of points including an origin point and a destination point, where the at least one route includes a plurality of routes, where each route of the plurality of routes corresponds to a different route from the origin point to the destination point, and where the plurality of routes includes at least one of a multimodal route, an intermodal route, or an intramodal route. Also, the device may be included in a plurality of devices, and each route of the at least one route may apply to each corresponding device of the plurality of devices.

At 1304, the device may obtain a set of device parameters for one or more route segments from a server (e.g., a cloud server, a third party server, an edge server, a network, or a network entity), where the set of device parameters for the one or more route segments includes an indication of an operation of the device along each of the one or more route segments, as discussed with respect to FIGS. 4-11. For example, as described in 1132 of FIG. 11, the device 1102 may obtain a set of device parameters for one or more route segments from a server, where the set of device parameters for the one or more route segments includes an indication of an operation of the device along each of the one or more route segments. Further, step 1304 may be performed by parameter component 198. The set of device parameters may include at least one of: one or more assistance data download parameters, one or more positioning parameters, one or more motion parameters, one or more sensor parameters, one or more connectivity parameters, one or more sleep parameters, or a combination thereof. The one or more assistance data download parameters may include at least one of: route-specific data, one or more alternative routes, global navigation satellite system (GNSS) assistance data, or a combination thereof. The one or more positioning parameters may include at least one of: an indication of positioning technologies for each of the one or more route segments, an expected accuracy of the one or more positioning parameters, an expected latency of the one or more positioning parameters, a weighting scheme of the one or more positioning parameters, one or more fallback options associated with the one or more positioning parameters, one or more situations for waveform samples associated with the one or more positioning parameters, one or more locations to batch prior to reporting the set of device parameters, or a combination thereof. The one or more motion parameters may indicate one or more motion patterns for triggering at least one of: a wake-up time, a sleep time, a report time, a location determination, or a combination thereof. The one or more sensor parameters may indicate one or more sensor threshold parameters for device reporting, a reporting time for the device, a reporting period for the device, or a combination thereof. The one or more connectivity parameters may indicate at least one of: a connection time for the device to connect with a network, a small data transmission (SDT) feature for at least one device mode, a compression for an SDT payload, or a combination thereof. The one or more sleep parameters may indicate at least one of: the sleep time, a sleep triggering event, a wake-up triggering event, or a combination thereof.

At 1306, the device may set one or more device parameters of the set of device parameters for the one or more route segments based on a proximity of the device to a corresponding route segment of the one or more route segments, as discussed with respect to FIGS. 4-11. For example, as described in 1140 of FIG. 11, the device 1102 may set one or more device parameters of the set of device parameters for the one or more route segments based on a proximity of the device to a corresponding route segment of the one or more route segments. Further, step 1306 may be performed by parameter component 198. The one or more device parameters may be set prior to a movement of the device along the one or more route segments, or the one or more device parameters may be set dynamically during the one or more route segments. The one or more route segments may be based on a set of route conditions or a set of environmental conditions associated with the one or more route segments. The set of route conditions may include at least one of a set of expected road conditions or a power status of the device, and the set of environmental conditions may include a set of expected environmental conditions associated with the one or more route segments. The one or more route segments may be based on at least one of sensor data associated with the device, a package type of at least one transport object of the device, a sensitivity of the at least one transport object of the device, or a combination thereof.

At 1308, the device may receive an indication of a reporting capability of the device, where the reporting capability indicates whether the device includes a capability to report on behalf of one or more additional devices, as discussed with respect to FIGS. 4-11. For example, as described in 1152 of FIG. 11, the device 1102 may receive an indication of a reporting capability of the device, where the reporting capability indicates whether the device includes a capability to report on behalf of one or more additional devices. Further, step 1308 may be performed by parameter component 198.

At 1310, the device may configure one or more sensors of the device based on the set of device parameters for the one or more route segments, as discussed with respect to FIGS. 4-11. For example, as described in 1160 of FIG. 11, the device 1102 may configure one or more sensors of the device based on the set of device parameters for the one or more route segments. Further, step 1310 may be performed by parameter component 198. The one or more route segments may be based on at least one of: an absolute geofence, a relative geofence, one or more timers, or a combination thereof.

At 1312, the device may monitor for at least one transmission-reception point (TRP) corresponding to a relative distance to at least one other geofence associated with the absolute geofence or the relative geofence; and select a sleep duration based on an expected time to travel the relative distance to the at least one other geofence, as discussed with respect to FIGS. 4-11. For example, as described in 1170 of FIG. 11, the device 1102 may monitor for at least one transmission-reception point (TRP) corresponding to a relative distance to at least one other geofence associated with the absolute geofence or the relative geofence; and select a sleep duration based on an expected time to travel the relative distance to the at least one other geofence. Further, step 1312 may be performed by parameter component 198.

At 1314, the device may update at least one of sensing data or the set of device parameters for the one or more route segments based on one or more route conditions along the one or more route segments; and transmit a second indication of at least one of the updated sensing data or the updated set of device parameters, where the second indication is transmitted to the server, as discussed with respect to FIGS. 4-11. For example, as described in 1180 of FIG. 11, the device 1102 may update at least one of sensing data or the set of device parameters for the one or more route segments based on one or more route conditions along the one or more route segments; and transmit a second indication of at least one of the updated sensing data or the updated set of device parameters, where the second indication is transmitted to the server. Further, step 1314 may be performed by parameter component 198.

At 1316, the device may receive a warning indication from the server if a location of the device is greater than a threshold distance from at least one of a list of target locations for the one or more route segments, where the location of the device is based on the updated sensing data or the updated set of device parameters, as discussed with respect to FIGS. 4-11. For example, as described in 1192 of FIG. 11, the device 1102 may receive a warning indication from the server if a location of the device is greater than a threshold distance from at least one of a list of target locations for the one or more route segments, where the location of the device is based on the updated sensing data or the updated set of device parameters. Further, step 1316 may be performed by parameter component 198.

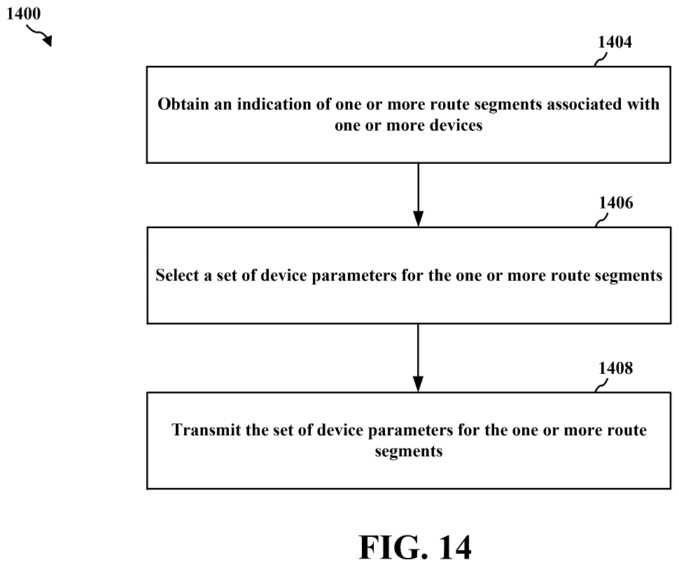

FIG. 14 is a flowchart 1400 of a method of wireless communication. The method may be performed by a server (e.g., server 704, server 804, server 904, server 1004, server 1104, a cloud server, a third party server, an edge server, etc.) or a network entity (e.g., LMF 166; network entity 1860) or a base station (e.g., the base station 102; the network entity 1702). The methods described herein may provide a number of benefits, such as improving resource utilization and/or power savings.

At 1404, the server may obtain an indication of one or more route segments associated with one or more devices, as discussed with respect to FIGS. 4-11. For example, as described in 1120 of FIG. 11, the server 1104 may obtain an indication of one or more route segments associated with one or more devices. Further, step 1404 may be performed by parameter component 199. The one or more route segments may be associated with at least one route with a plurality of points including an origin point and a destination point, where the at least one route includes a plurality of routes, where each route of the plurality of routes may correspond to a different route from the origin point to the destination point, and where the plurality of routes includes at least one of a multimodal route, an intermodal route, or an intramodal route. The one or more devices may include a plurality of devices, where each route of the at least one route applies to each corresponding device of the plurality of devices, and where the indication may be obtained based on at least one of: information from at least one external source, information from at least one internal source, information from a database, a machine learning (ML) model, a neural network (NN) model, or a combination thereof.

At 1406, the server may select a set of device parameters for the one or more route segments, where the set of device parameters for the one or more route segments includes an indication of an operation of the one or more devices along each of the one or more route segments, where one or more device parameters of the set of device parameters are based on a proximity of the one or more devices to a corresponding route segment of the one or more route segments, as discussed with respect to FIGS. 4-11. For example, as described in 1122 of FIG. 11, the server 1104 may select a set of device parameters for the one or more route segments, where the set of device parameters for the one or more route segments includes an indication of an operation of the one or more devices along each of the one or more route segments, where one or more device parameters of the set of device parameters are based on a proximity of the one or more devices to a corresponding route segment of the one or more route segments. Further, step 1406 may be performed by parameter component 199. The set of device parameters may include at least one of: one or more assistance data download parameters, one or more positioning parameters, one or more motion parameters, one or more sensor parameters, one or more connectivity parameters, one or more sleep parameters, or a combination thereof. The one or more assistance data download parameters may include at least one of: route-specific data, one or more alternative routes, global navigation satellite system (GNSS) assistance data, or a combination thereof. The one or more positioning parameters may include at least one of: an indication of positioning technologies for each of the one or more route segments, an expected accuracy of the one or more positioning parameters, an expected latency of the one or more positioning parameters, a weighting scheme of the one or more positioning parameters, one or more fallback options associated with the one or more positioning parameters, one or more situations for waveform samples associated with the one or more positioning parameters, one or more locations to batch prior to reporting the set of device parameters, or a combination thereof. The one or more motion parameters may indicate one or more motion patterns for triggering at least one of: a wake-up time, a sleep time, a report time, a location determination, or a combination thereof. The one or more sensor parameters may indicate one or more sensor threshold parameters for device reporting, a reporting time for the device, a reporting period for the device, or a combination thereof. The one or more connectivity parameters may indicate at least one of: a connection time for the device to connect with a network, a small data transmission (SDT) feature for at least one device mode, a compression for an SDT payload, or a combination thereof. The one or more sleep parameters may indicate at least one of: the sleep time, a sleep triggering event, a wake-up triggering event, or a combination thereof.

At 1408, the server may transmit the set of device parameters for the one or more route segments to the one or more devices, as discussed with respect to FIGS. 4-11. For example, as described in 1130 of FIG. 11, the server 1104 may transmit the set of device parameters for the one or more route segments to the one or more devices. Further, step 1408 may be performed by parameter component 199.

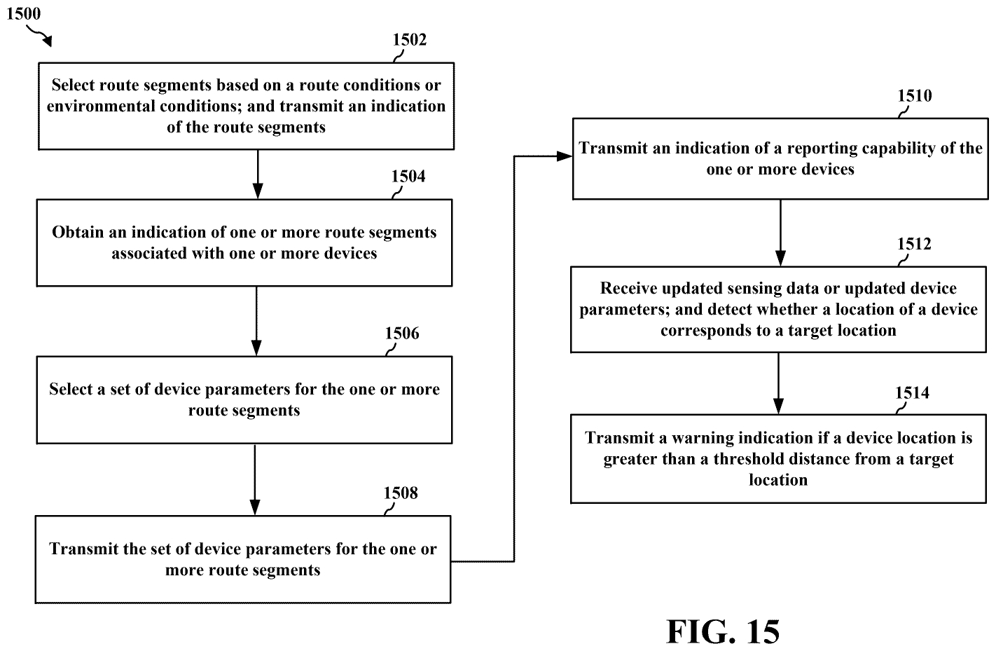

FIG. 15 is a flowchart 1500 of a method of wireless communication. The method may be performed by a server (e.g., server 704, server 804, server 904, server 1004, server 1104, a cloud server, a third party server, an edge server, etc.) or a network entity (e.g., LMF 166; network entity 1860) or a base station (e.g., the base station 102; the network entity 1702). The methods described herein may provide a number of benefits, such as improving resource utilization and/or power savings.

At 1502, the server may select one or more route segments based on a set of route conditions or a set of environmental conditions associated with the one or more route segments; and transmit a second indication of the selected one or more route segments, as discussed with respect to FIGS. 4-11. For example, as described in 1110 of FIG. 11, the server 1104 may select one or more route segments based on a set of route conditions or a set of environmental conditions associated with the one or more route segments; and transmit a second indication of the selected one or more route segments. Further, step 1502 may be performed by parameter component 199. The one or more route segments may be based on at least one of: an absolute geofence, a relative geofence, one or more timers, or a combination thereof. The set of route conditions may include at least one of a set of expected road conditions or a power status of the one or more devices, and the set of environmental conditions may include a set of expected environmental conditions associated with the one or more route segments. The one or more route segments may be based on at least one of sensor data associated with the one or more devices, a package type of at least one transport object of the one or more devices, a sensitivity of the at least one transport object of the one or more devices, or a combination thereof.

At 1504, the server may obtain an indication of one or more route segments associated with one or more devices, as discussed with respect to FIGS. 4-11. For example, as described in 1120 of FIG. 11, the server 1104 may obtain an indication of one or more route segments associated with one or more devices. Further, step 1504 may be performed by parameter component 199. The one or more route segments may be associated with at least one route with a plurality of points including an origin point and a destination point, where the at least one route includes a plurality of routes, where each route of the plurality of routes may correspond to a different route from the origin point to the destination point, and where the plurality of routes includes at least one of a multimodal route, an intermodal route, or an intramodal route. The one or more devices may include a plurality of devices, where each route of the at least one route applies to each corresponding device of the plurality of devices, and where the indication may be obtained based on at least one of: information from at least one external source, information from at least one internal source, information from a database, a machine learning (ML) model, a neural network (NN) model, or a combination thereof.

At 1506, the server may select a set of device parameters for the one or more route segments, where the set of device parameters for the one or more route segments includes an indication of an operation of the one or more devices along each of the one or more route segments, where one or more device parameters of the set of device parameters are based on a proximity of the one or more devices to a corresponding route segment of the one or more route segments, as discussed with respect to FIGS. 4-11. For example, as described in 1122 of FIG. 11, the server 1104 may select a set of device parameters for the one or more route segments, where the set of device parameters for the one or more route segments includes an indication of an operation of the one or more devices along each of the one or more route segments, where one or more device parameters of the set of device parameters are based on a proximity of the one or more devices to a corresponding route segment of the one or more route segments. Further, step 1506 may be performed by parameter component 199. The set of device parameters may include at least one of: one or more assistance data download parameters, one or more positioning parameters, one or more motion parameters, one or more sensor parameters, one or more connectivity parameters, one or more sleep parameters, or a combination thereof. The one or more assistance data download parameters may include at least one of: route-specific data, one or more alternative routes, global navigation satellite system (GNSS) assistance data, or a combination thereof. The one or more positioning parameters may include at least one of: an indication of positioning technologies for each of the one or more route segments, an expected accuracy of the one or more positioning parameters, an expected latency of the one or more positioning parameters, a weighting scheme of the one or more positioning parameters, one or more fallback options associated with the one or more positioning parameters, one or more situations for waveform samples associated with the one or more positioning parameters, one or more locations to batch prior to reporting the set of device parameters, or a combination thereof. The one or more motion parameters may indicate one or more motion patterns for triggering at least one of: a wake-up time, a sleep time, a report time, a location determination, or a combination thereof. The one or more sensor parameters may indicate one or more sensor threshold parameters for device reporting, a reporting time for the device, a reporting period for the device, or a combination thereof. The one or more connectivity parameters may indicate at least one of: a connection time for the device to connect with a network, a small data transmission (SDT) feature for at least one device mode, a compression for an SDT payload, or a combination thereof. The one or more sleep parameters may indicate at least one of: the sleep time, a sleep triggering event, a wake-up triggering event, or a combination thereof.

At 1508, the server may transmit the set of device parameters for the one or more route segments to the one or more devices, as discussed with respect to FIGS. 4-11. For example, as described in 1130 of FIG. 11, the server 1104 may transmit the set of device parameters for the one or more route segments to the one or more devices. Further, step 1508 may be performed by parameter component 199.

At 1510, the server may transmit an indication of a reporting capability of each of the one or more devices, where the reporting capability indicates whether each of the one or more devices includes a capability to report on behalf of one or more additional devices, as discussed with respect to FIGS. 4-11. For example, as described in 1150 of FIG. 11, the server 1104 may transmit an indication of a reporting capability of each of the one or more devices, where the reporting capability indicates whether each of the one or more devices includes a capability to report on behalf of one or more additional devices. Further, step 1510 may be performed by parameter component 199.

At 1512, the server may receive a second indication of at least one of updated sensing data or an updated set of device parameters; and detect whether a location of the one or more devices corresponds to a list of target locations for the one or more route segments based on at least one of the updated sensing data or the updated set of device parameters, as discussed with respect to FIGS. 4-11. For example, as described in 1182 of FIG. 11, the server 1104 may receive a second indication of at least one of updated sensing data or an updated set of device parameters; and detect whether a location of the one or more devices corresponds to a list of target locations for the one or more route segments based on at least one of the updated sensing data or the updated set of device parameters. Further, step 1512 may be performed by parameter component 199.

At 1514, the server may transmit a warning indication to at least one device of the one or more devices if the location of the at least one device is greater than a threshold distance from at least one of the list of target locations for the one or more route segments, as discussed with respect to FIGS. 4-11. For example, as described in 1190 of FIG. 11, the server 1104 may transmit a warning indication to at least one device of the one or more devices if the location of the at least one device is greater than a threshold distance from at least one of the list of target locations for the one or more route segments. Further, step 1514 may be performed by parameter component 199.

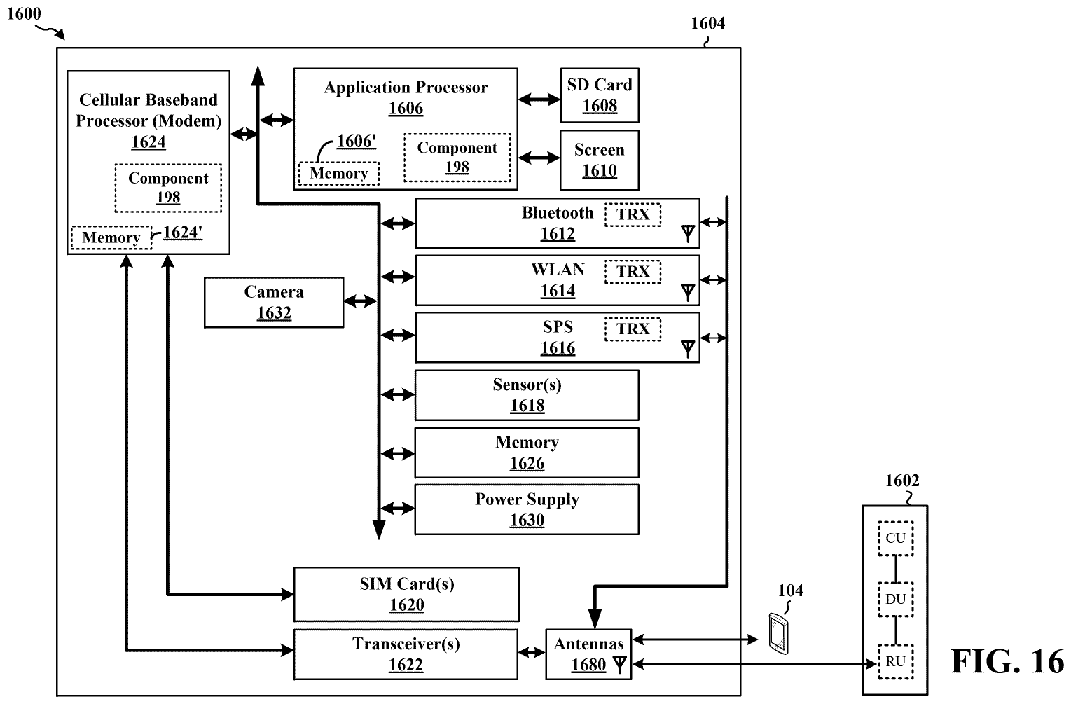

FIG. 16 is a diagram 1600 illustrating an example of a hardware implementation for an apparatus 1604. The apparatus 1604 may be a device, a wireless device, a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see 350 of FIG. 3) and include the additional modules of the apparatus 1604.

As discussed supra, the parameter component 198 may be configured to obtain a set of device parameters for one or more route segments from a server, where the set of device parameters for the one or more route segments includes an indication of an operation of the device along each of the one or more route segments. The parameter component 198 may also be configured to set one or more device parameters of the set of device parameters for the one or more route segments based on a proximity of the device to a corresponding route segment of the one or more route segments. The parameter component 198 may also be configured to configure one or more sensors of the device based on the set of device parameters for the one or more route segments. The parameter component 198 may also be configured to update at least one of sensing data or the set of device parameters for the one or more route segments based on one or more route conditions along the one or more route segments; and transmit a second indication of at least one of the updated sensing data or the updated set of device parameters, where the second indication is transmitted to the server. The parameter component 198 may also be configured to receive a warning indication from the server if a location of the device is greater than a threshold distance from at least one of a list of target locations for the one or more route segments, where the location of the device is based on the updated sensing data or the updated set of device parameters. The parameter component 198 may also be configured to monitor for at least one transmission-reception point (TRP) corresponding to a relative distance to at least one other geofence associated with the absolute geofence or the relative geofence; and select a sleep duration based on an expected time to travel the relative distance to the at least one other geofence. The parameter component 198 may also be configured to receive an indication of a reporting capability of the device, where the reporting capability indicates whether the device includes a capability to report on behalf of one or more additional devices. The parameter component 198 may also be configured to obtain an indication of the one or more route segments prior to obtaining the set of device parameters, where the indication is obtained based on at least one of: information from at least one external source, information from at least one internal source, information from a database, a machine learning (ML) model, a neural network (NN) model, or a combination thereof.

The parameter component 198 may be within the cellular baseband processor 1624, the application processor 1606, or both the cellular baseband processor 1624 and the application processor 1606. The parameter component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for obtaining a set of device parameters for one or more route segments from a server, where the set of device parameters for the one or more route segments includes an indication of an operation of the device along each of the one or more route segments. The apparatus 1604 may also include means for setting one or more device parameters of the set of device parameters for the one or more route segments based on a proximity of the device to a corresponding route segment of the one or more route segments. The apparatus 1604 may also include means for configuring one or more sensors of the device based on the set of device parameters for the one or more route segments. The apparatus 1604 may also include means for updating at least one of sensing data or the set of device parameters for the one or more route segments based on one or more route conditions along the one or more route segments; and means for transmitting a second indication of at least one of the updated sensing data or the updated set of device parameters, where the second indication is transmitted to the server. The apparatus 1604 may also include means for receiving a warning indication from the server if a location of the device is greater than a threshold distance from at least one of a list of target locations for the one or more route segments, where the location of the device is based on the updated sensing data or the updated set of device parameters. The apparatus 1604 may also include means for monitoring for at least one transmission-reception point (TRP) corresponding to a relative distance to at least one other geofence associated with the absolute geofence or the relative geofence; and means for selecting a sleep duration based on an expected time to travel the relative distance to the at least one other geofence. The apparatus 1604 may also include means for receiving an indication of a reporting capability of the device, where the reporting capability indicates whether the device includes a capability to report on behalf of one or more additional devices. The apparatus 1604 may also include means for obtaining an indication of the one or more route segments prior to obtaining the set of device parameters, where the indication is obtained based on at least one of: information from at least one external source, information from at least one internal source, information from a database, a machine learning (ML) model, a neural network (NN) model, or a combination thereof. The means may be the parameter component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

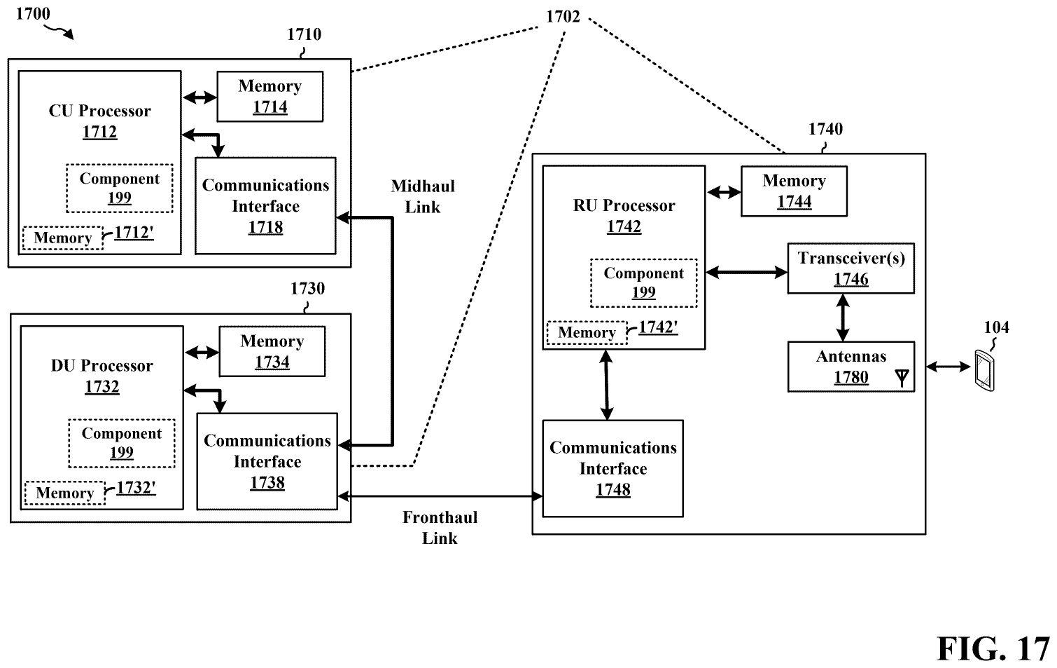

FIG. 17 is a diagram 1700 illustrating an example of a hardware implementation for a network entity 1702. The network entity 1702 may be a server (e.g., a cloud server, a third party server, an edge server, etc.), a BS, a component of a BS, or may implement BS functionality. The network entity 1702 may include at least one of a CU 1710, a DU 1730, or an RU 1740. For example, depending on the layer functionality handled by the parameter component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the parameter component 199 may be configured to obtain an indication of one or more route segments associated with one or more devices. The parameter component 199 may also be configured to select a set of device parameters for the one or more route segments, where the set of device parameters for the one or more route segments includes an indication of an operation of the one or more devices along each of the one or more route segments, where one or more device parameters of the set of device parameters are based on a proximity of the one or more devices to a corresponding route segment of the one or more route segments. The parameter component 199 may also be configured to transmit the set of device parameters for the one or more route segments to the one or more devices. The parameter component 199 may also be configured to receive a second indication of at least one of updated sensing data or an updated set of device parameters; and detect whether a location of the one or more devices corresponds to a list of target locations for the one or more route segments based on at least one of the updated sensing data or the updated set of device parameters. The parameter component 199 may also be configured to transmit a warning indication to at least one device of the one or more devices if the location of the at least one device is greater than a threshold distance from at least one of the list of target locations for the one or more route segments. The parameter component 199 may also be configured to select the one or more route segments based on a set of route conditions or a set of environmental conditions associated with the one or more route segments; and transmit a second indication of the selected one or more route segments. The parameter component 199 may also be configured to transmit an indication of a reporting capability of each of the one or more devices, where the reporting capability indicates whether each of the one or more devices includes a capability to report on behalf of one or more additional devices.

The parameter component 199 may be within one or more processors of one or more of the CU 1710, DU 1730, and the RU 1740. The parameter component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 may include means for obtaining an indication of one or more route segments associated with one or more devices. The network entity 1702 may also include means for selecting a set of device parameters for the one or more route segments, where the set of device parameters for the one or more route segments includes an indication of an operation of the one or more devices along each of the one or more route segments, where one or more device parameters of the set of device parameters are based on a proximity of the one or more devices to a corresponding route segment of the one or more route segments. The network entity 1702 may also include means for transmitting the set of device parameters for the one or more route segments to the one or more devices. The network entity 1702 may also include means for receiving a second indication of at least one of updated sensing data or an updated set of device parameters; and means for detecting whether a location of the one or more devices corresponds to a list of target locations for the one or more route segments based on at least one of the updated sensing data or the updated set of device parameters. The network entity 1702 may also include means for transmitting a warning indication to at least one device of the one or more devices if the location of the at least one device is greater than a threshold distance from at least one of the list of target locations for the one or more route segments. The network entity 1702 may also include means for selecting the one or more route segments based on a set of route conditions or a set of environmental conditions associated with the one or more route segments; and means for transmitting a second indication of the selected one or more route segments. The network entity 1702 may also include means for transmitting an indication of a reporting capability of each of the one or more devices, where the reporting capability indicates whether each of the one or more devices includes a capability to report on behalf of one or more additional devices. The means may be the parameter component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

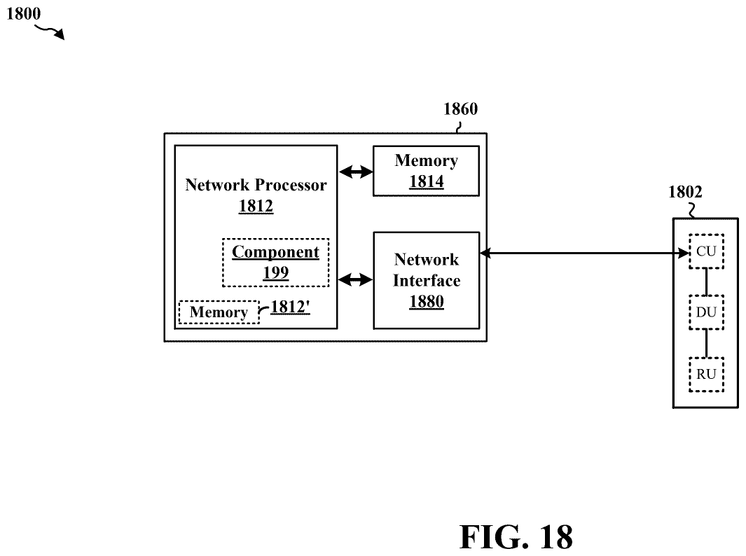

FIG. 18 is a diagram 1800 illustrating an example of a hardware implementation for a network entity 1860. In one example, the network entity 1860 may be within the core network 120. The network entity 1860 may include a network processor 1812. The network processor 1812 may include on-chip memory 1812′. In some aspects, the network entity 1860 may further include additional memory modules 1814. The network entity 1860 communicates via the network interface 1880 directly (e.g., backhaul link) or indirectly (e.g., through a RIC) with the CU 1802. The on-chip memory 1812′ and the additional memory modules 1814 may each be considered a computer-readable medium/memory. Each computer-readable medium/memory may be non-transitory. The processor 1812 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the parameter component 199 may be configured to obtain an indication of one or more route segments associated with one or more devices. The parameter component 199 may also be configured to select a set of device parameters for the one or more route segments, where the set of device parameters for the one or more route segments includes an indication of an operation of the one or more devices along each of the one or more route segments, where one or more device parameters of the set of device parameters are based on a proximity of the one or more devices to a corresponding route segment of the one or more route segments. The parameter component 199 may also be configured to transmit the set of device parameters for the one or more route segments to the one or more devices. The parameter component 199 may also be configured to receive a second indication of at least one of updated sensing data or an updated set of device parameters; and detect whether a location of the one or more devices corresponds to a list of target locations for the one or more route segments based on at least one of the updated sensing data or the updated set of device parameters. The parameter component 199 may also be configured to transmit a warning indication to at least one device of the one or more devices if the location of the at least one device is greater than a threshold distance from at least one of the list of target locations for the one or more route segments. The parameter component 199 may also be configured to select the one or more route segments based on a set of route conditions or a set of environmental conditions associated with the one or more route segments; and transmit a second indication of the selected one or more route segments. The parameter component 199 may also be configured to transmit an indication of a reporting capability of each of the one or more devices, where the reporting capability indicates whether each of the one or more devices includes a capability to report on behalf of one or more additional devices.

The parameter component 199 may be within the processor 1812. The parameter component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1860 may include a variety of components configured for various functions. In one configuration, the network entity 1860 may include means for obtaining an indication of one or more route segments associated with one or more devices. The network entity 1860 may also include means for selecting a set of device parameters for the one or more route segments, where the set of device parameters for the one or more route segments includes an indication of an operation of the one or more devices along each of the one or more route segments, where one or more device parameters of the set of device parameters are based on a proximity of the one or more devices to a corresponding route segment of the one or more route segments. The network entity 1860 may also include means for transmitting the set of device parameters for the one or more route segments to the one or more devices. The network entity 1860 may also include means for receiving a second indication of at least one of updated sensing data or an updated set of device parameters; and means for detecting whether a location of the one or more devices corresponds to a list of target locations for the one or more route segments based on at least one of the updated sensing data or the updated set of device parameters. The network entity 1860 may also include means for transmitting a warning indication to at least one device of the one or more devices if the location of the at least one device is greater than a threshold distance from at least one of the list of target locations for the one or more route segments. The network entity 1860 may also include means for selecting the one or more route segments based on a set of route conditions or a set of environmental conditions associated with the one or more route segments; and means for transmitting a second indication of the selected one or more route segments. The network entity 1860 may also include means for transmitting an indication of a reporting capability of each of the one or more devices, where the reporting capability indicates whether each of the one or more devices includes a capability to report on behalf of one or more additional devices. The means may be the parameter component 199 of the network entity 1860 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a device, including a memory and at least one processor coupled to the memory and, based at least in part on information stored in the memory, the at least one processor is configured to: obtain a set of device parameters for one or more route segments from a server, where the set of device parameters for the one or more route segments includes an indication of an operation of the device along each of the one or more route segments; and set one or more device parameters of the set of device parameters for the one or more route segments based on a proximity of the device to a corresponding route segment of the one or more route segments.

Aspect 2 is the apparatus of aspect 1, where the at least one processor is further configured to: configure one or more sensors of the device based on the set of device parameters for the one or more route segments.

Aspect 3 is the apparatus of any of aspects 1 and 2, where the one or more device parameters are set prior to a movement of the device along the one or more route segments, or where the one or more device parameters are set dynamically during the one or more route segments.

Aspect 4 is the apparatus of any of aspects 1 to 3, where the at least one processor is further configured to: update at least one of sensing data or the set of device parameters for the one or more route segments based on one or more route conditions along the one or more route segments; and transmit a second indication of at least one of the updated sensing data or the updated set of device parameters, where the second indication is transmitted to the server.

Aspect 5 is the apparatus of any of aspects 1 to 4, where the at least one processor is further configured to: receive a warning indication from the server if a location of the device is greater than a threshold distance from at least one of a list of target locations for the one or more route segments, where the location of the device is based on the updated sensing data or the updated set of device parameters.

Aspect 6 is the apparatus of any of aspects 1 to 5, where the one or more route segments are based on at least one of: an absolute geofence, a relative geofence, one or more timers, or a combination thereof.

Aspect 7 is the apparatus of any of aspects 1 to 6, where the at least one processor is further configured to: monitor for at least one transmission-reception point (TRP) corresponding to a relative distance to at least one other geofence associated with the absolute geofence or the relative geofence; and select a sleep duration based on an expected time to travel the relative distance to the at least one other geofence.

Aspect 8 is the apparatus of any of aspects 1 to 7, where the set of device parameters includes at least one of: one or more assistance data download parameters, one or more positioning parameters, one or more motion parameters, one or more sensor parameters, one or more connectivity parameters, one or more sleep parameters, or a combination thereof.

Aspect 9 is the apparatus of any of aspects 1 to 8, where the one or more assistance data download parameters include at least one of: route-specific data, one or more alternative routes, global navigation satellite system (GNSS) assistance data, or a combination thereof; where the one or more positioning parameters include at least one of: an indication of positioning technologies for each of the one or more route segments, an expected accuracy of the one or more positioning parameters, an expected latency of the one or more positioning parameters, a weighting scheme of the one or more positioning parameters, one or more fallback options associated with the one or more positioning parameters, one or more situations for waveform samples associated with the one or more positioning parameters, one or more locations to batch prior to reporting the set of device parameters, or a combination thereof; where the one or more motion parameters indicate one or more motion patterns for triggering at least one of: a wake-up time, a sleep time, a report time, a location determination, or a combination thereof; where the one or more sensor parameters indicate one or more sensor threshold parameters for device reporting, a reporting time for the device, a reporting period for the device, or a combination thereof; where the one or more connectivity parameters indicate at least one of: a connection time for the device to connect with a network, a small data transmission (SDT) feature for at least one device mode, a compression for an SDT payload, or a combination thereof; or where the one or more sleep parameters indicate at least one of: the sleep time, a sleep triggering event, a wake-up triggering event, or a combination thereof.

Aspect 10 is the apparatus of any of aspects 1 to 9, where the one or more route segments are based on a set of route conditions or a set of environmental conditions associated with the one or more route segments.

Aspect 11 is the apparatus of any of aspects 1 to 10, where the set of route conditions include at least one of a set of expected road conditions or a power status of the device, and where the set of environmental conditions includes a set of expected environmental conditions associated with the one or more route segments.

Aspect 12 is the apparatus of any of aspects 1 to 11, where the one or more route segments are based on at least one of sensor data associated with the device, a package type of at least one transport object of the device, a sensitivity of the at least one transport object of the device, or a combination thereof.

Aspect 13 is the apparatus of any of aspects 1 to 12, where the at least one processor is further configured to: receive an indication of a reporting capability of the device, where the reporting capability indicates whether the device includes a capability to report on behalf of one or more additional devices.

Aspect 14 is the apparatus of any of aspects 1 to 13, where the one or more route segments are associated with at least one route with a plurality of points including an origin point and a destination point, where the at least one route includes a plurality of routes, where each route of the plurality of routes corresponds to a different route from the origin point to the destination point, and where the plurality of routes includes at least one of a multimodal route, an intermodal route, or an intramodal route.

Aspect 15 is the apparatus of any of aspects 1 to 14, where the device is included in a plurality of devices, and where each route of the at least one route applies to each corresponding device of the plurality of devices.

Aspect 16 is the apparatus of any of aspects 1 to 15, where the at least one processor is further configured to: obtain an indication of the one or more route segments prior to obtaining the set of device parameters, where the indication is obtained based on at least one of: information from at least one external source, information from at least one internal source, information from a database, a machine learning (ML) model, a neural network (NN) model, or a combination thereof.

Aspect 17 is an apparatus for device configuration at a server (e.g., a cloud server, a third party server, an edge server, a network, or a network entity), including a memory and at least one processor coupled to the memory and, based at least in part on information stored in the memory, the at least one processor is configured to: obtain an indication of one or more route segments associated with one or more devices; select a set of device parameters for the one or more route segments, where the set of device parameters for the one or more route segments includes an indication of an operation of the one or more devices along each of the one or more route segments, where one or more device parameters of the set of device parameters are based on a proximity of the one or more devices to a corresponding route segment of the one or more route segments; and transmit the set of device parameters for the one or more route segments to the one or more devices.

Aspect 18 is the apparatus of aspect 17, where the at least one processor is further configured to: receive a second indication of at least one of updated sensing data or an updated set of device parameters; and detect whether a location of the one or more devices corresponds to a list of target locations for the one or more route segments based on at least one of the updated sensing data or the updated set of device parameters.

Aspect 19 is the apparatus of any of aspects 17 to 18, where the at least one processor is further configured to: transmit a warning indication to at least one device of the one or more devices if the location of the at least one device is greater than a threshold distance from at least one of the list of target locations for the one or more route segments.

Aspect 20 is the apparatus of any of aspects 17 to 19, where the one or more route segments are based on at least one of: an absolute geofence, a relative geofence, one or more timers, or a combination thereof.

Aspect 21 is the apparatus of any of aspects 17 to 20, where the set of device parameters includes at least one of: one or more assistance data download parameters, one or more positioning parameters, one or more motion parameters, one or more sensor parameters, one or more connectivity parameters, one or more sleep parameters, or a combination thereof.

Aspect 22 is the apparatus of any of aspects 17 to 21, where the one or more assistance data download parameters include at least one of: route-specific data, one or more alternative routes, global navigation satellite system (GNSS) assistance data, or a combination thereof; where the one or more positioning parameters include at least one of: an indication of positioning technologies for each of the one or more route segments, an expected accuracy of the one or more positioning parameters, an expected latency of the one or more positioning parameters, a weighting scheme of the one or more positioning parameters, one or more fallback options associated with the one or more positioning parameters, one or more situations for waveform samples associated with the one or more positioning parameters, one or more locations to batch prior to reporting the set of device parameters, or a combination thereof; where the one or more motion parameters indicate one or more motion patterns for triggering at least one of: a wake-up time, a sleep time, a report time, a location determination, or a combination thereof; where the one or more sensor parameters indicate one or more sensor threshold parameters for device reporting, a reporting time for the one or more devices, a reporting period for the one or more devices, or a combination thereof; where the one or more connectivity parameters indicate at least one of: a connection time for the one or more devices to connect with a network, a small data transmission (SDT) feature for at least one device mode, a compression for an SDT payload, or a combination thereof; or where the one or more sleep parameters indicate at least one of: the sleep time, a sleep triggering event, a wake-up triggering event, or a combination thereof.

Aspect 23 is the apparatus of any of aspects 17 to 22, where the at least one processor is further configured to: select the one or more route segments based on a set of route conditions or a set of environmental conditions associated with the one or more route segments; and transmit a second indication of the selected one or more route segments.

Aspect 24 is the apparatus of any of aspects 17 to 23, where the set of route conditions include at least one of a set of expected road conditions or a power status of the one or more devices, and where the set of environmental conditions includes a set of expected environmental conditions associated with the one or more route segments.

Aspect 25 is the apparatus of any of aspects 17 to 24, where the one or more route segments are based on at least one of sensor data associated with the one or more devices, a package type of at least one transport object of the one or more devices, a sensitivity of the at least one transport object of the one or more devices, or a combination thereof.

Aspect 26 is the apparatus of any of aspects 17 to 25, where the at least one processor is further configured to: transmit an indication of a reporting capability of each of the one or more devices, where the reporting capability indicates whether each of the one or more devices includes a capability to report on behalf of one or more additional devices.

Aspect 27 is the apparatus of any of aspects 17 to 26, where the one or more route segments are associated with at least one route with a plurality of points including an origin point and a destination point, where the at least one route includes a plurality of routes, where each route of the plurality of routes corresponds to a different route from the origin point to the destination point, and where the plurality of routes includes at least one of a multimodal route, an intermodal route, or an intramodal route.

Aspect 28 is the apparatus of any of aspects 17 to 27, where the one or more devices include a plurality of devices, where each route of the at least one route applies to each corresponding device of the plurality of devices, and where the indication is obtained based on at least one of: information from at least one external source, information from at least one internal source, information from a database, a machine learning (ML) model, a neural network (NN) model, or a combination thereof.

Aspect 29 is the apparatus of any of aspects 1 to 28, where the apparatus is a wireless communication device, further including at least one of an antenna or a transceiver coupled to the at least one processor.

Aspect 30 is a method of wireless communication for implementing any of aspects 1 to 29.

Aspect 31 is an apparatus for wireless communication including means for implementing any of aspects 1 to 29.

Aspect 32 is a computer-readable medium (e.g., a non-transitory computer-readable medium) storing computer executable code, the code when executed by at least one processor causes the at least one processor to implement any of aspects 1 to 29.

What is claimed is:

1. An apparatus for wireless communication at a device, comprising:
a memory; and
at least one processor coupled to the memory and, based at least in part on first information stored in the memory, the at least one processor is configured to:
obtain a set of device parameters for one or more route segments from a server, wherein the set of device parameters for the one or more route segments includes an indication of an operation of the device along each of the one or more route segments; and
set one or more device parameters of the set of device parameters for the one or more route segments based on a proximity of the device to a corresponding route segment of the one or more route segments.

2. The apparatus of claim 1, wherein the at least one processor is further configured to:
configure one or more sensors of the device based on the set of device parameters for the one or more route segments.

3. The apparatus of claim 1, wherein the one or more device parameters are set prior to a movement of the device along the one or more route segments, or wherein the one or more device parameters are set dynamically during the one or more route segments.

4. The apparatus of claim 1, wherein the at least one processor is further configured to:
update at least one of sensing data or the set of device parameters for the one or more route segments based on one or more route conditions along the one or more route segments; and
transmit a second indication of at least one of the updated sensing data or the updated set of device parameters, wherein the second indication is transmitted to the server.

5. The apparatus of claim 4, wherein the at least one processor is further configured to:
receive a warning indication from the server if a location of the device is greater than a threshold distance from at least one of a list of target locations for the one or more route segments, wherein the location of the device is based on the updated sensing data or the updated set of device parameters.

6. The apparatus of claim 1, wherein the one or more route segments are based on at least one of: an absolute geofence, a relative geofence, one or more timers, or a combination thereof.

7. The apparatus of claim 6, wherein the at least one processor is further configured to:
monitor for at least one transmission-reception point (TRP) corresponding to a relative distance to at least one other geofence associated with the absolute geofence or the relative geofence; and
select a sleep duration based on an expected time to travel the relative distance to the at least one other geofence.

8. The apparatus of claim 1, wherein the set of device parameters includes at least one of: one or more assistance data download parameters, one or more positioning parameters, one or more motion parameters, one or more sensor parameters, one or more connectivity parameters, one or more sleep parameters, or a combination thereof.

9. The apparatus of claim 8, wherein the one or more assistance data download parameters include at least one of: route-specific data, one or more alternative routes, global navigation satellite system (GNSS) assistance data, or a combination thereof;
wherein the one or more positioning parameters include at least one of: an indication of positioning technologies for each of the one or more route segments, an expected accuracy of the one or more positioning parameters, an expected latency of the one or more positioning parameters, a weighting scheme of the one or more positioning parameters, one or more fallback options associated with the one or more positioning parameters, one or more situations for waveform samples associated with the one or more positioning parameters, one or more locations to batch prior to reporting the set of device parameters, or a combination thereof;
wherein the one or more motion parameters indicate one or more motion patterns for triggering at least one of: a wake-up time, a sleep time, a report time, a location determination, or a combination thereof;
wherein the one or more sensor parameters indicate one or more sensor threshold parameters for device reporting, a reporting time for the device, a reporting period for the device, or a combination thereof;
wherein the one or more connectivity parameters indicate at least one of: a connection time for the device to connect with a network, a small data transmission (SDT) feature for at least one device mode, a compression for an SDT payload, or a combination thereof; or
wherein the one or more sleep parameters indicate at least one of: the sleep time, a sleep triggering event, a wake-up triggering event, or a combination thereof.

10. The apparatus of claim 1, wherein the one or more route segments are based on a set of route conditions or a set of environmental conditions associated with the one or more route segments.

11. The apparatus of claim 10, wherein the set of route conditions include at least one of a set of expected road conditions or a power status of the device, and wherein the set of environmental conditions includes a set of expected environmental conditions associated with the one or more route segments.

12. The apparatus of claim 10, wherein the one or more route segments are based on at least one of sensor data associated with the device, a package type of at least one transport object of the device, a sensitivity of the at least one transport object of the device, or a combination thereof.

13. The apparatus of claim 1, wherein the at least one processor is further configured to:
receive an indication of a reporting capability of the device, wherein the reporting capability indicates whether the device includes a capability to report on behalf of one or more additional devices.

14. The apparatus of claim 1, wherein the one or more route segments are associated with at least one route with a plurality of points including an origin point and a destination point, wherein the at least one route includes a plurality of routes, wherein each route of the plurality of routes corresponds to a different route from the origin point to the destination point, and wherein the plurality of routes includes at least one of a multimodal route, an intermodal route, or an intramodal route.

15. The apparatus of claim 14, wherein the device is included in a plurality of devices, and wherein each route of the at least one route applies to each corresponding device of the plurality of devices.

16. The apparatus of claim 1, wherein the at least one processor is further configured to:
obtain an indication of the one or more route segments prior to obtaining the set of device parameters, wherein the indication is obtained based on at least one of: information from at least one external source, information from at least one internal source, information from a database, a machine learning (ML) model, a neural network (NN) model, or a combination thereof.

17. An apparatus for device configuration at a server, comprising:
a memory; and
at least one processor coupled to the memory and, based at least in part on first information stored in the memory, the at least one processor is configured to:
obtain an indication of one or more route segments associated with one or more devices;
select a set of device parameters for the one or more route segments, wherein the set of device parameters for the one or more route segments includes an indication of an operation of the one or more devices along each of the one or more route segments, wherein one or more device parameters of the set of device parameters are based on a proximity of the one or more devices to a corresponding route segment of the one or more route segments; and
transmit the set of device parameters for the one or more route segments to the one or more devices.

18. The apparatus of claim 17, wherein the at least one processor is further configured to:
receive a second indication of at least one of updated sensing data or an updated set of device parameters; and
detect whether a location of the one or more devices corresponds to a list of target locations for the one or more route segments based on at least one of the updated sensing data or the updated set of device parameters.

19. The apparatus of claim 18, wherein the at least one processor is further configured to:
transmit a warning indication to at least one device of the one or more devices if the location of the at least one device is greater than a threshold distance from at least one of the list of target locations for the one or more route segments.

20. The apparatus of claim 17, wherein the one or more route segments are based on at least one of: an absolute geofence, a relative geofence, one or more timers, or a combination thereof.

21. The apparatus of claim 17, wherein the set of device parameters includes at least one of: one or more assistance data download parameters, one or more positioning parameters, one or more motion parameters, one or more sensor parameters, one or more connectivity parameters, one or more sleep parameters, or a combination thereof.

22. The apparatus of claim 21, wherein the one or more assistance data download parameters include at least one of: route-specific data, one or more alternative routes, global navigation satellite system (GNSS) assistance data, or a combination thereof;
wherein the one or more positioning parameters include at least one of: an indication of positioning technologies for each of the one or more route segments, an expected accuracy of the one or more positioning parameters, an expected latency of the one or more positioning parameters, a weighting scheme of the one or more positioning parameters, one or more fallback options associated with the one or more positioning parameters, one or more situations for waveform samples associated with the one or more positioning parameters, one or more locations to batch prior to reporting the set of device parameters, or a combination thereof;
wherein the one or more motion parameters indicate one or more motion patterns for triggering at least one of: a wake-up time, a sleep time, a report time, a location determination, or a combination thereof;
wherein the one or more sensor parameters indicate one or more sensor threshold parameters for device reporting, a reporting time for the one or more devices, a reporting period for the one or more devices, or a combination thereof;
wherein the one or more connectivity parameters indicate at least one of: a connection time for the one or more devices to connect with a network, a small data transmission (SDT) feature for at least one device mode, a compression for an SDT payload, or a combination thereof; or
wherein the one or more sleep parameters indicate at least one of: the sleep time, a sleep triggering event, a wake-up triggering event, or a combination thereof.

23. The apparatus of claim 17, wherein the at least one processor is further configured to:
select the one or more route segments based on a set of route conditions or a set of environmental conditions associated with the one or more route segments; and
transmit a second indication of the selected one or more route segments.

24. The apparatus of claim 23, wherein the set of route conditions include at least one of a set of expected road conditions or a power status of the one or more devices, and wherein the set of environmental conditions includes a set of expected environmental conditions associated with the one or more route segments.

25. The apparatus of claim 23, wherein the one or more route segments are based on at least one of sensor data associated with the one or more devices, a package type of at least one transport object of the one or more devices, a sensitivity of the at least one transport object of the one or more devices, or a combination thereof.

26. The apparatus of claim 17, wherein the at least one processor is further configured to:
transmit an indication of a reporting capability of each of the one or more devices, wherein the reporting capability indicates whether each of the one or more devices includes a capability to report on behalf of one or more additional devices.

27. The apparatus of claim 17, wherein the one or more route segments are associated with at least one route with a plurality of points including an origin point and a destination point, wherein the at least one route includes a plurality of routes, wherein each route of the plurality of routes corresponds to a different route from the origin point to the destination point, and wherein the plurality of routes includes at least one of a multimodal route, an intermodal route, or an intramodal route.

28. The apparatus of claim 27, wherein the one or more devices include a plurality of devices, wherein each route of the at least one route applies to each corresponding device of the plurality of devices, and wherein the indication is obtained based on at least one of: information from at least one external source, information from at least one internal source, information from a database, a machine learning (ML) model, a neural network (NN) model, or a combination thereof.

29. A method of wireless communication at a device, comprising:
obtaining a set of device parameters for one or more route segments from a server, wherein the set of device parameters for the one or more route segments includes an indication of an operation of the device along each of the one or more route segments; and
setting one or more device parameters of the set of device parameters for the one or more route segments based on a proximity of the device to a corresponding route segment of the one or more route segments.

30. A method of device configuration at a server, comprising:
obtaining an indication of one or more route segments associated with one or more devices;
selecting a set of device parameters for the one or more route segments, wherein the set of device parameters for the one or more route segments includes an indication of an operation of the one or more devices along each of the one or more route segments, wherein one or more device parameters of the set of device parameters are based on a proximity of the one or more devices to a corresponding route segment of the one or more route segments; and
transmitting the set of device parameters for the one or more route segments to the one or more devices.
